(19) United States
(12) Patent Application Publication
(10) Pub. No.: US 2025/0226541 A1
(43) Pub. Date: Jul. 10, 2025

(54) BATTERY CELL ASSEMBLY AND ELECTRIC DEVICE

(71) Applicant: Xiamen Ampack Technology Limited, Xiamen (CN)

(72) Inventors: Shenbo WANG, Xiamen (CN); Xianjin LING, Xiamen (CN); Pengcheng YANG, Xiamen (CN); Yu CHEN, Xiamen (CN)

(73) Assignee: Xiamen Ampack Technology Limited, Xiamen (CN)

(21) Appl. No.: 19/094,197

(22) Filed: Mar. 28, 2025

Related U.S. Application Data
(63) Continuation of application No. PCT/CN2022/123557, filed on Sep. 30, 2022.

(51) Int. Cl. H01M 50/503; H01M 50/211; H01M 50/516; H01M 50/553

(52) U.S. Cl. CPC H01M 50/503; H01M 50/211; H01M 50/516; H01M 50/553

(57) ABSTRACT

A battery cell assembly includes a cell assembly, a holder, and N conducting sheets. The cell assembly includes M cells stacked along a first direction. Each cell includes a cell housing, an electrode terminal, and an electrode assembly disposed within the cell housing. The electrode terminal is connected to the electrode assembly and extends out of the cell housing. A welding part is provided on a portion of the electrode terminal located outside the cell housing. Along the first direction, a projection of the welding part of the each cell is spaced apart from a projection of the welding part of an adjacent cell. The N conducting sheets are spaced apart within the holder. At least a portion of each conducting sheet is exposed through the holder. The electrode terminals pass through the holder. The welding part is connected to the portion of the conducting sheet exposed through the holder.

### CROSS REFERENCE TO THE RELATED APPLICATIONS

This application is a continuation application of International Application No. PCT/CN2022/123557, filed on Sep. 30, 2022, the content of which is incorporated herein by reference in its entirety.

### TECHNICAL FIELD

This application relates to the field of energy storage technologies, and in particular, to a battery cell assembly and an electric device.

### BACKGROUND

In a battery cell assembly, cells are typically stacked, and electrode terminals of each cell overlap in a stacking direction, resulting in limited welding space and close proximity between the electrode terminals of adjacent cells stacked. This is not conducive to the connection of the electrode terminals.

### SUMMARY

In view of this, it is necessary to provide a battery cell assembly and an electric device to facilitate the connection of electrode terminals.

An embodiment of this application provides a battery cell assembly including a cell assembly, a holder, and N conducting sheets. The cell assembly includes M cells stacked along a first direction. Each cell includes a cell housing, an electrode terminal, and an electrode assembly disposed within the cell housing. The electrode terminal is connected to the electrode assembly and extends out of the cell housing. A welding part is provided on a portion of the electrode terminal located outside the cell housing. Along the first direction, a projection of the welding part of the each cell is spaced apart from a projection of the welding part of an adjacent cell. The N conducting sheets are disposed on the holder and spaced apart from each. At least a portion of each conducting sheet is exposed through the holder. The electrode terminals pass through the holder. The welding part is connected to the portion of the conducting sheet exposed through the holder. With the welding parts of the electrode terminals of adjacent cells being arranged in a non-overlapping manner in the first direction, the risk of short circuits between the welding parts of the adjacent electrode terminals is reduced, facilitating the connection of the electrode terminals.

Optionally, in some embodiments of this application, the holder is provided with a recess. The recess includes a first recess and a second recess spaced apart along a second direction. The conducting sheets include a plurality of first conducting sheets and a plurality of second conducting sheets. The first conducting sheets are disposed on the first recess. The second conducting sheets are disposed on the second recess. The electrode terminal includes a first terminal and a second terminal with opposite polarities. one of the first terminal or the second terminal of each cell positioned between a first cell and an M-th cell is disposed on the first recess and connected to the first conducting sheet, and the other of the first termina or the second terminal of the each cell positioned between the first cell and the M-th cell is disposed on the second recess and connected to the second conducting sheet. The second direction is perpendicular to the first direction.

Optionally, in some embodiments of this application, first protrusions are provided both between adjacent first conducting sheets and between adjacent second conducting sheets. Along the first direction, a projection of the welding part is located within a projection of the first protrusion. The adjacent first conducting sheets and the electrode terminals connected to the first conducting sheets are spaced apart to reduce the risk of an electrode terminal, in bending, coming into contact with an adjacent first conducting sheet and coming into contact with an adjacent electrode terminal.

Optionally, in some embodiments of this application, t for each cell positioned between a second cell and an M−1-th cell, one welding part of the each cell positioned between the second cell and the M−1-th cell and one welding part of the cell adjacent to the each cell positioned between the second cell and the M−1-th cell is connected to a same first conducting sheet or a same second conducting sheet as the welding part of the electrode terminal of the cell adjacent to the each cell positioned between the second cell and the M−1-th cell, facilitating the connection of the electrode terminals.

Optionally, in some embodiments of this application, the conducting sheets further include a third conducting sheet. The recess further comprises a third recess. The first recess and the third recess are spaced apart along the first direction. The third conducting sheet is at least partially exposed to the third recess. The second terminal of the M-th cell is connected to the third conducting sheet and is connected to the portion of the third conducting sheet exposed to the third recess.

Optionally, in some embodiments of this application, the holder includes a substrate and a plurality of second protrusions. The substrate includes a first surface and a second surface disposed opposite to each other along a third direction. The recess is disposed on the first surface. The plurality of second protrusions are spaced apart on the second surface. Along the first direction, a projection of the electrode terminal overlaps with a projection of the second protrusion. The third direction is perpendicular to both the first direction and the second direction. The second protrusion provides insulation for a portion of the electrode terminal, reducing the risk of short circuits.

Optionally, in some embodiments of this application, the cell housing includes a first portion and a second portion. The electrode assembly is disposed on the first portion. The second portion is connected to the first portion. The electrode terminal is connected to the electrode assembly and extends out of the second portion. Along the first direction, a projection of the second portion overlaps with a projection of the second protrusion. Disposing at least a portion of the second portion and the entire electrode terminal between adjacent second protrusions further reduces the risk of short circuits.

Optionally, in some embodiments of this application, a plurality of spaced first partitions are provided between adjacent second protrusions. Along the first direction, a projection of the first partitions is located between a projection of the first terminal and a projection of the second terminal in the same first recess, or between a projection of the first terminal and a projection of the second terminal in the same second recess. The first partition facilitates guiding the first terminals and the second terminals and separating the first terminal and the second terminal of each cell from each other, reducing the contact between the electrode terminals and those of adjacent cells.

Optionally, in some embodiments of this application, the substrate includes a first side edge and a second side edge disposed along the first direction. A first side wall extending along the third direction is provided on the first side edge. A second side wall extending along the third direction is provided on the second side edge. Along the first direction, the second protrusion is disposed between the first side wall and the second side wall. Along the first direction, the projection of the second protrusion is located within a projection of the first side wall and a projection of the second side wall. In this way, the second protrusions can provide further insulation protection for the electrode terminals located between adjacent second protrusions, reducing the risk of short circuits.

Optionally, in some embodiments of this application, the conducting sheets further include a fourth conducting sheet. The fourth conducting sheet is partially disposed on a side of the first side edge away from the second side edge. The first terminal of the first cell is connected to the fourth conducting sheet.

Optionally, in some embodiments of this application, a fourth recess is provided on a side of the first side wall away from the second side wall. The fourth recess communicates with the first recess. The electrode terminal is partially disposed on the fourth recess and extends into the first recess. Along the second direction, a projection of a portion of the electrode terminal is located within a projection of the fourth recess.

Optionally, in some embodiments of this application, the substrate includes a third side edge and a fourth side edge disposed along the second direction. A plurality of third protrusions spaced apart along the first direction are provided on the third side edge. A plurality of fourth protrusions spaced apart along the first direction are provided on the fourth side edge. Along the second direction, the second protrusions are disposed between the third protrusions and the fourth protrusions, and along the first direction, the projection of the second portion overlaps with a projection of the third protrusions and a projection of the fourth protrusions, facilitating the positioning of the second portion.

Optionally, in some embodiments of this application, the second protrusion includes a first inclined surface. An adjacent second protrusion includes a second inclined surface. A distance between the first inclined surface and the second inclined surface along the first direction gradually increases in the third direction. This creates a flared gap between a third inclined surface and a fourth inclined surface, facilitating the guiding of the second portion into a gap between adjacent third protrusions.

Optionally, in some embodiments of this application, the welding part passes through the substrate and is connected to the first conducting sheets. Along the third direction, a projection of the welding part overlaps with a projection of the first conducting sheet.

Optionally, in some embodiments of this application, the first conducting sheet includes a first section and a second section, the welding parts of the second terminals of odd-numbered cells are connected to the first section. The welding parts of the first terminals of even-numbered cells are connected to the second section. When viewed along the third direction, along the first direction, a width of the welding part is greater than a width of the first section, a width of the welding part is greater than a width of the second section. This ensures that the connection area between each welding part and the first section, as well as between each welding part and the second section, is the same, improving the consistency of individual cells.

Optionally, in some embodiments of this application, along the third direction, a projection of the welding part overlaps with a projection of the adjacent cell. This can increase the width of the welding part in the first direction, thereby increasing the welding area between the welding part and the conducting sheet.

Optionally, in some embodiments of this application, a circuit board is further included. Each conducting sheet further comprises conducting extension parts. The conducting extension parts extend out of the substrate and are connected to the circuit board.

Optionally, in some embodiments of this application, a housing is further included. The cells and the holder are accommodated within the housing. The circuit board is disposed on a side of the housing away from the cells. The housing is provided with a plurality of first holes. The conducting extension parts pass through the first holes and are connected to the circuit board.

Optionally, in some embodiments of this application, an insulating member is further included. The insulating member is disposed between the housing and the cells.

Optionally, in some embodiments of this application, each conducting sheet further includes a connecting part. The connecting part is disposed within the substrate, and the connecting part is connected to the conducting extension part.

Optionally, in some embodiments of this application, the electrode terminals of adjacent cells are disposed at different positions on the cell housings. Along the second direction, a width of the first terminal is W₁. A width of the second terminal is W₂. Along the second direction, a distance between opposing edges of the first terminal and the second terminal of one cell is W₃ and a distance between opposing edges of the first terminal and the second terminal of another adjacent cell is W₄, satisfying W₁+W₂+W₄<W₃.

Optionally, in some embodiments of this application, the electrode terminal of each of the cells is disposed at a same position on the cell housings. The cell housing includes a first side edge and a second side edge arranged along the second direction. Along the second direction, a distance between the first side edge and the second side edge is W. A distance between an edge of the first terminal close to the first side edge and the first side edge is F₁, a distance between an edge of the second terminal close to the second side edge and the second side edge is F₂, a width of the first terminal is W₁, and a width of the second terminal is W₂, satisfying F₁+W₁<F₂ and 2*(F₂+W₂)<W.

Optionally, in some embodiments of this application, along the second direction, a distance between the second terminals of adjacent cells is d, satisfying d=[W−F₁−F₁−2*(W₁+W₂)]/3.

An embodiment of this application further provides a battery cell assembly, including a cell assembly and N conducting sheets. The cell assembly includes M cells stacked along a first direction. Each cell includes a cell housing, an electrode terminal, and an electrode assembly disposed within the cell housing. The electrode terminal is connected to the electrode assembly and extends out of the cell housing. A welding part is provided on a portion of the electrode terminal located outside the cell housing. Along the first direction, a projection of the welding part of the each cell is spaced apart from a projection of the welding part of an adjacent cell, and M≥3. Adjacent cells are connected by the conducting sheets, and the welding part is connected to the conducting sheet. With the welding parts of the electrode terminals of adjacent cells being arranged in a non-overlapping manner in the first direction, the risk of short circuits between the welding parts of the adjacent electrode terminals is reduced, facilitating the connection of the electrode terminals.

Optionally, in some embodiments of this application, the electrode terminal includes a first terminal and a second terminal with opposite polarities, where the first terminal and the second terminal are arranged along a second direction, and the second terminal of any cell between the first cell and the M-th cell and the first terminal of an adjacent cell are connected to a same conducting sheet, with the second direction is perpendicular to the first direction, facilitating the connection of the electrode terminals.

Optionally, in some embodiments of this application, when viewed along a third direction, along the first direction, the welding parts of the first terminals of even-numbered cells are spaced apart from each other, the welding parts of the second terminals of odd-numbered cells are spaced apart from each other, the welding parts of the second terminals of the even-numbered cells are spaced apart from each other, and the welding parts of the first terminals of the odd-numbered cells are spaced apart from each other, with the third direction is perpendicular to both the first direction and the second direction. Utilizing the space of M cells along the second direction increases the volume of the battery cell assembly, reducing the risk of short circuits between the cells.

Optionally, in some embodiments of this application, the first terminal of the first cell serves as a first output terminal of the cell assembly. The second terminal of the M-th cell serves as a second output terminal of the cell assembly. The welding part of the second terminal of the first cell and the welding part of the first terminal of the second cell are connected by a same conducting sheet, facilitating the connection of the electrode terminals.

Optionally, in some embodiments of this application, the conducting sheets include a plurality of first conducting sheets and a plurality of second conducting sheets. When viewed along the third direction, along the first direction, the first conducting sheets and the second conducting sheets are spaced apart. Each of the first conducting sheets includes a first section and a second section for connecting the electrode terminals. Along the first direction, the first section of the same first conducting sheet is closer to the first cell than the second section, so that the second section of a first conducting sheet is closer to the M-th cell than the first section. By shifting the first section in the first recess away from the third recess, the area of the third recess is increased, thus increasing the welding area between the fourth conducting sheet in the third recess and the welding part of the second terminal of the M-th cell 11.

Optionally, in some embodiments of this application, M is an odd number, and each of the first sections is connected to the second terminals of the odd-numbered cells. Each of the second sections is connected to the first terminals of the even-numbered cells, facilitating the connection of the electrode terminals.

Optionally, in some embodiments of this application, M is an even number, and each of the first sections is connected to the second terminals of the even-numbered cells. Each of the second sections is connected to the first terminals of the odd-numbered cells, facilitating the connection of the electrode terminals.

Optionally, in some embodiments of this application, the first conducting sheet includes a first connecting segment connecting the first section and the second section. The first connecting segment is arranged at a first angle with respect to the first direction. The first angle is an obtuse angle, so that the second section of a first conducting sheet is closer to the M-th cell than the first section.

Optionally, in some embodiments of this application, each of the second conducting sheets includes a third section and a fourth section for connecting the electrode terminals. Along the first direction, a distance from the third section of the same second conducting sheet to the first cell is equal to a distance from the fourth section to the first cell.

Optionally, in some embodiments of this application, along the first direction, a distance from the second section to the first cell is equal to a distance from the third section to the first cell.

Optionally, in some embodiments of this application, M is an even number, and the third section is connected to the second terminals of the odd-numbered cells. The fourth section is connected to the first terminals of the even-numbered cells, facilitating the connection of the electrode terminals.

Optionally, in some embodiments of this application, M is an odd number, and the third section is connected to the second terminals of the even-numbered cells. The fourth section is connected to the first terminals of the odd-numbered cells, facilitating the connection of the electrode terminals.

Optionally, in some embodiments of this application, a circuit board is further included, and the conducting sheet includes a conducting extension part. The conducting sheet is configured to collect electrical signals from the cell and transmit the electrical signals to the circuit board.

Optionally, in some embodiments of this application, N=M+1.

An embodiment of this application further provides an electric device, including the battery cell assembly according to any one of the foregoing embodiments.

In the foregoing battery cell assembly and electric device, with the electrode terminals of adjacent cells being arranged in a non-overlapping manner in the first direction, the risk of short circuits between adjacent electrode terminals is reduced, facilitating the connection of the electrode terminals.

### BRIEF DESCRIPTION OF DRAWINGS

FIG. 1 is a schematic structural diagram of a cell assembly and a connecting assembly according to some embodiments.

FIG. 2 is a schematic structural diagram of a cell assembly and a connecting assembly from another perspective according to some embodiments.

FIG. 3 is a schematic structural diagram of a cell assembly and a connecting assembly from yet another perspective according to some embodiments.

FIG. 4 is an exploded schematic diagram of a cell assembly and a connecting assembly according to some embodiments.

FIG. 5 is a schematic structural diagram of cells stacked according to some embodiments.

FIG. 6 is a schematic structural diagram of a cell according to some embodiments.

FIG. 7 is an exploded schematic view of a cell according to some embodiments.

FIG. 8 is an exploded schematic view of a cell according to some other embodiments.

FIG. 9 is a schematic structural diagram of an electrode assembly according to some embodiments.

FIG. 10 is a schematic diagram of a front view structure of a cell according to some embodiments.

FIG. 11 is a schematic structural diagram of stacked cells shown in FIG. 10.

FIG. 12 is a schematic diagram of a front view structure of stacked cells shown in FIG. 11.

FIG. 13 is a schematic diagram of a front view structure of a cell according to some other embodiments.

FIG. 14 is a schematic diagram of a front view structure of a cell according to still some other embodiments.

FIG. 15 is a schematic structural diagram of stacked cells shown in FIG. 13 and

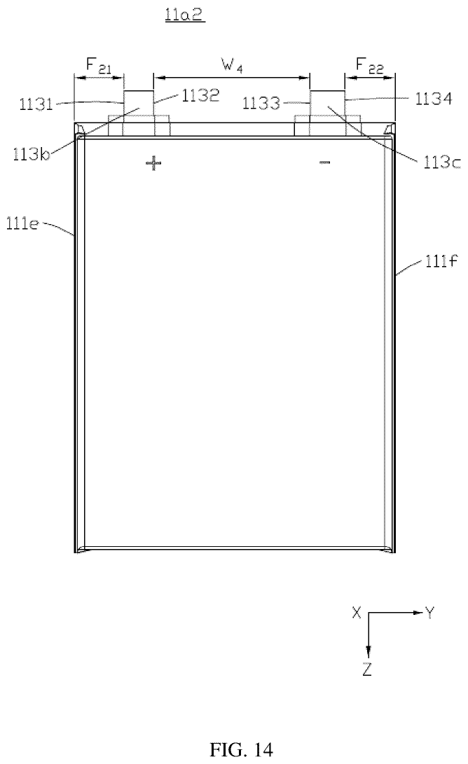

FIG. 14.

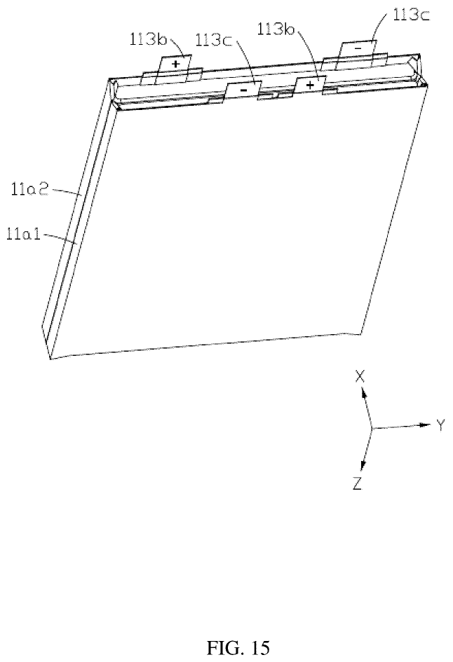

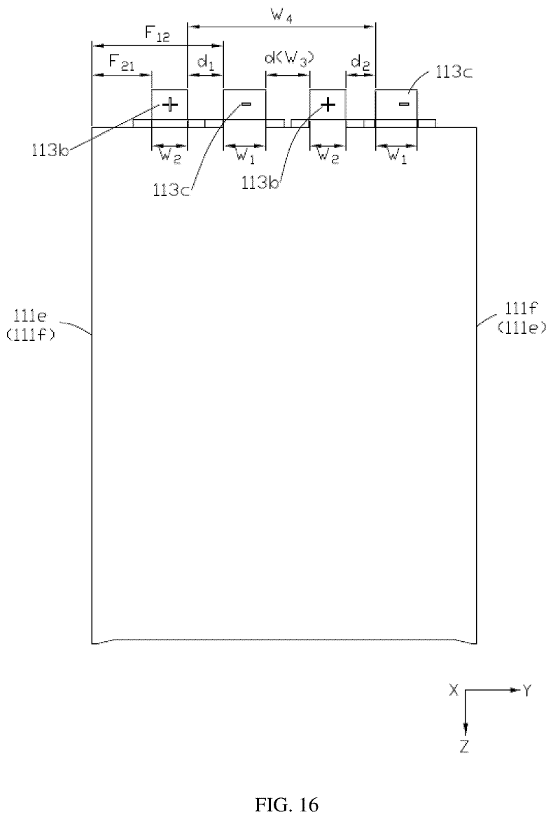

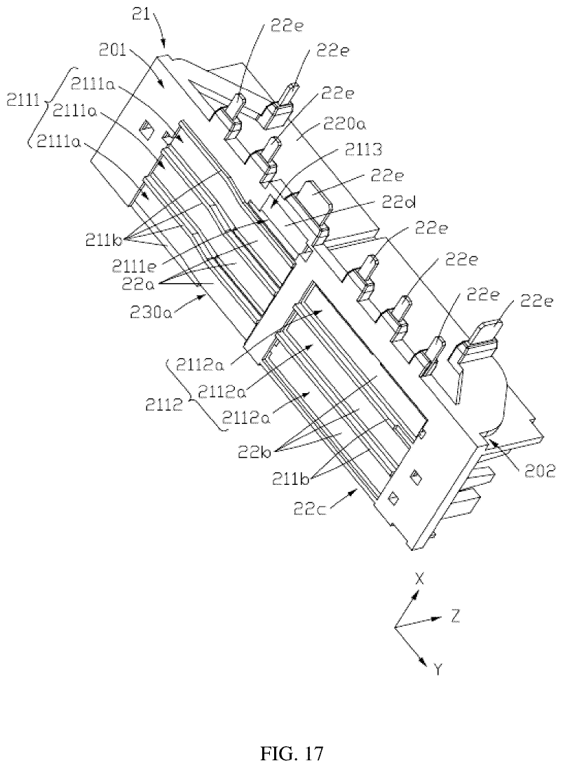

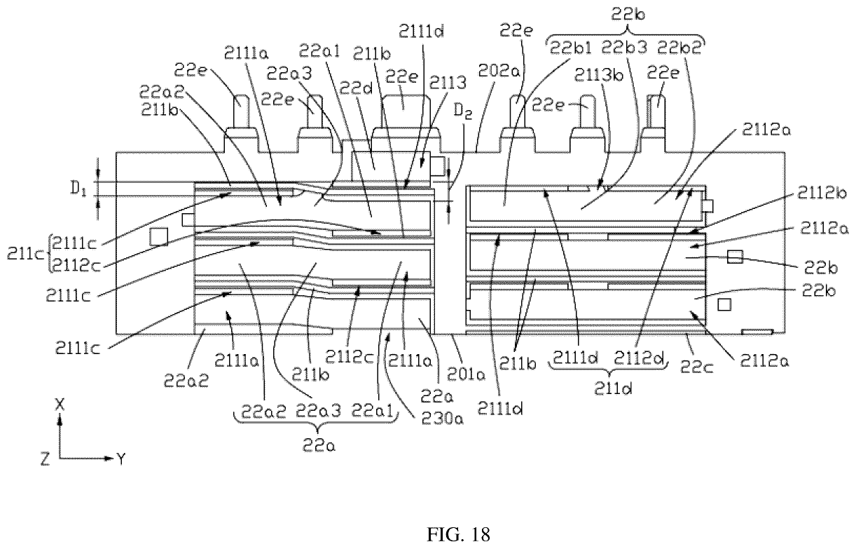

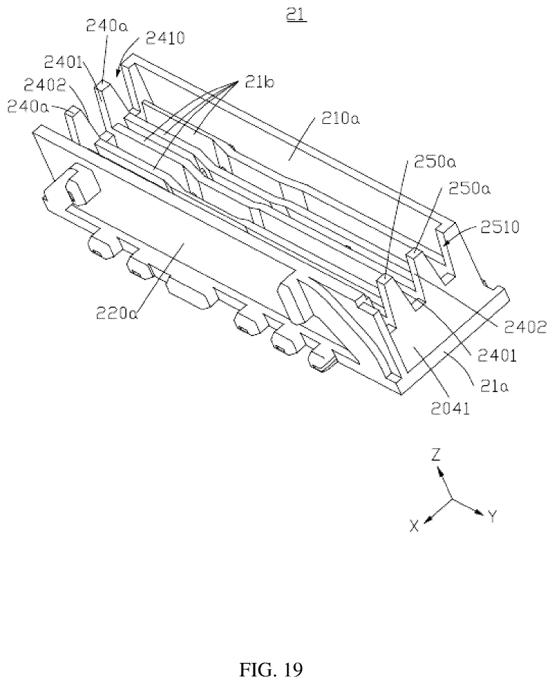

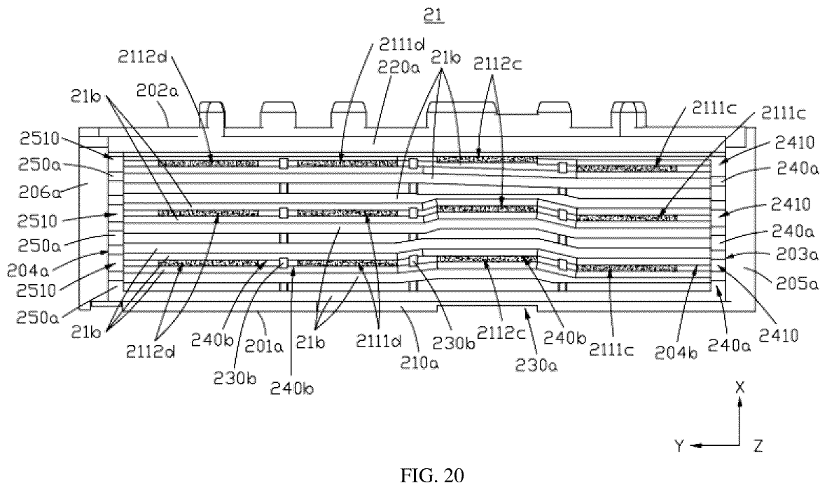

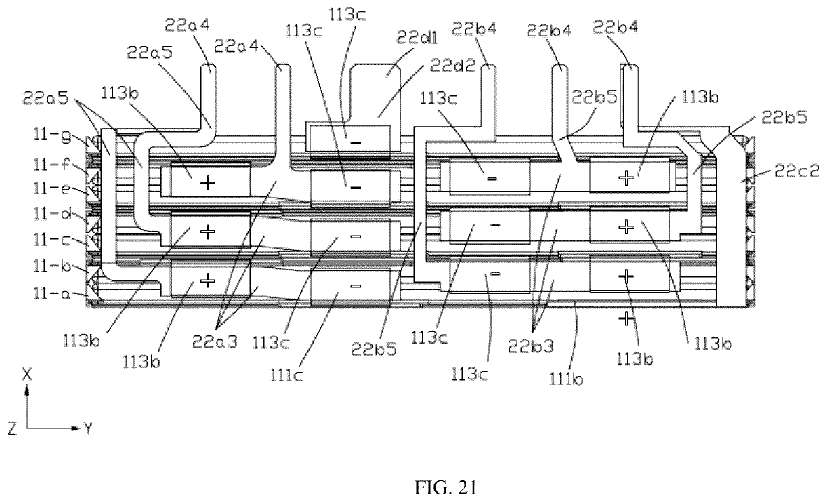

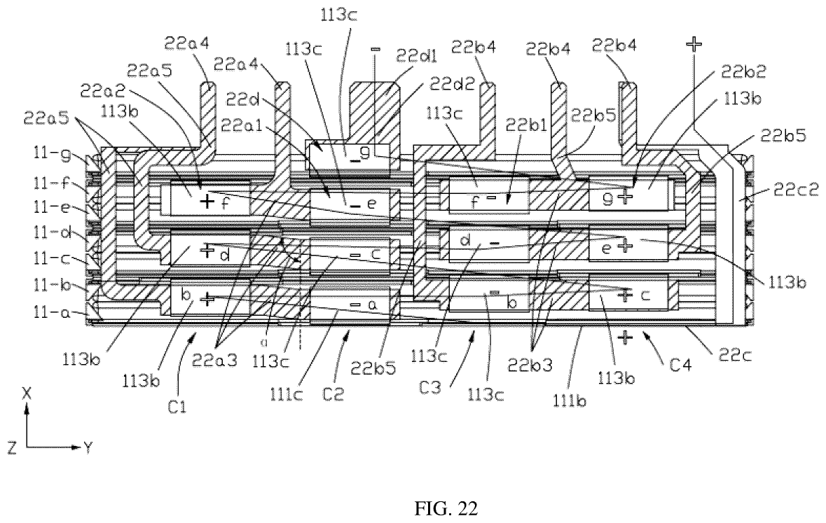

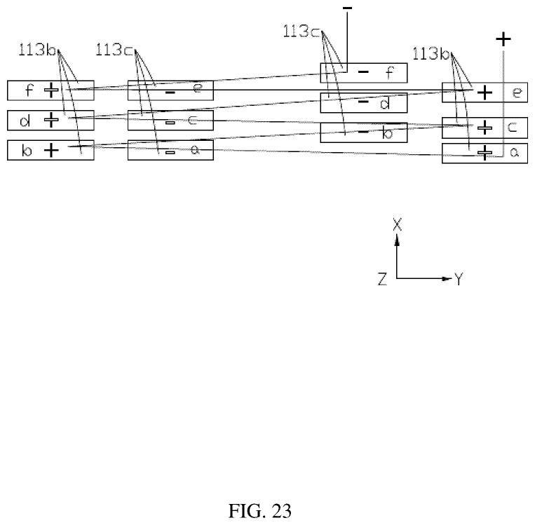

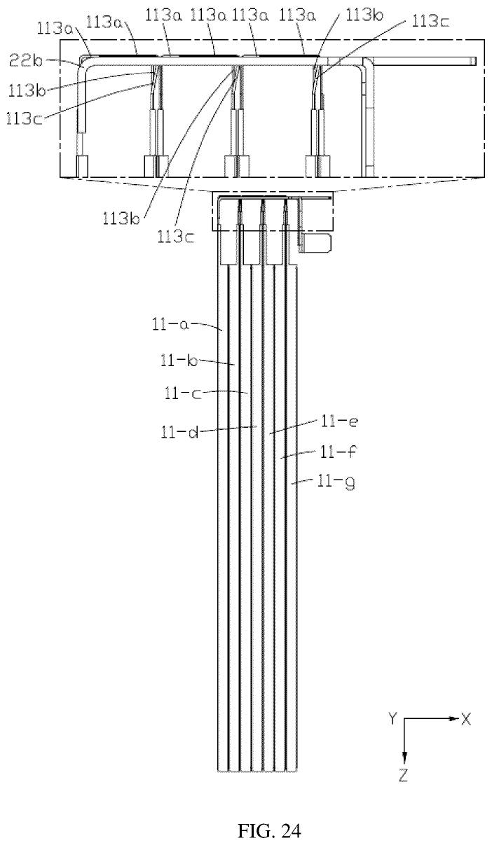

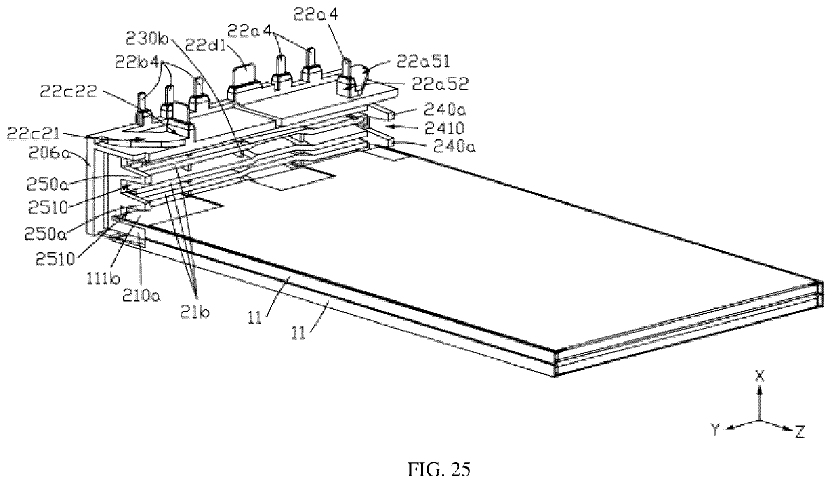

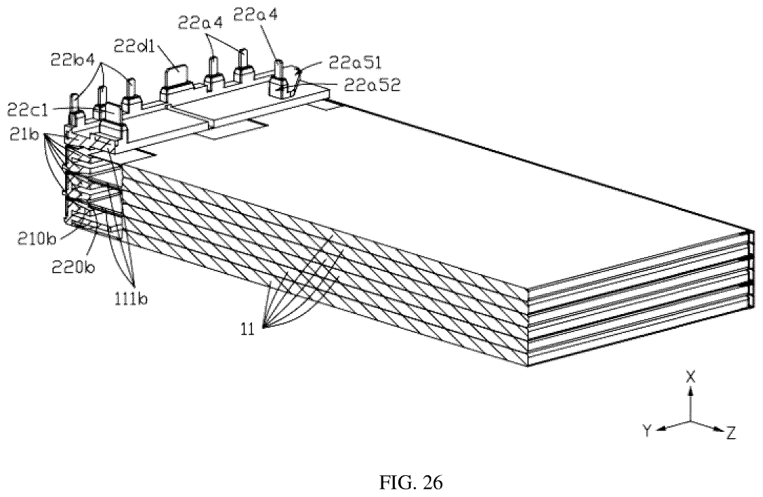

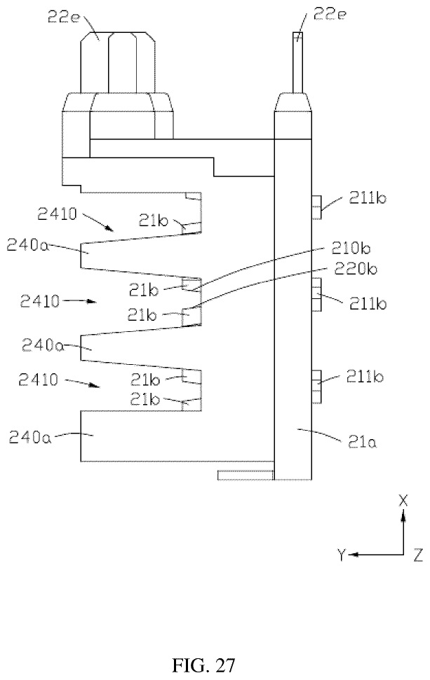

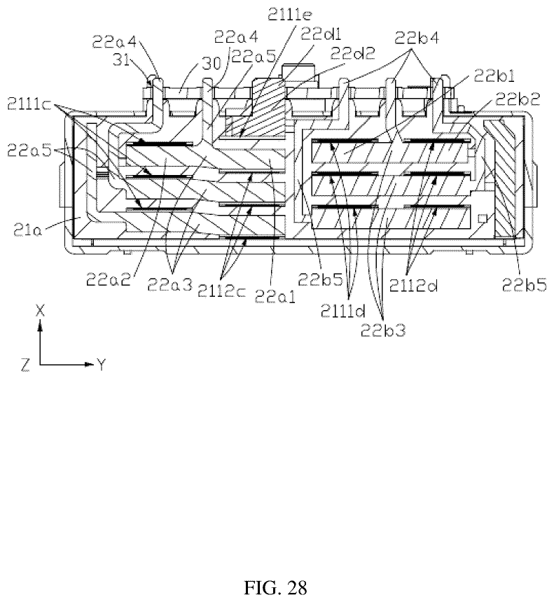

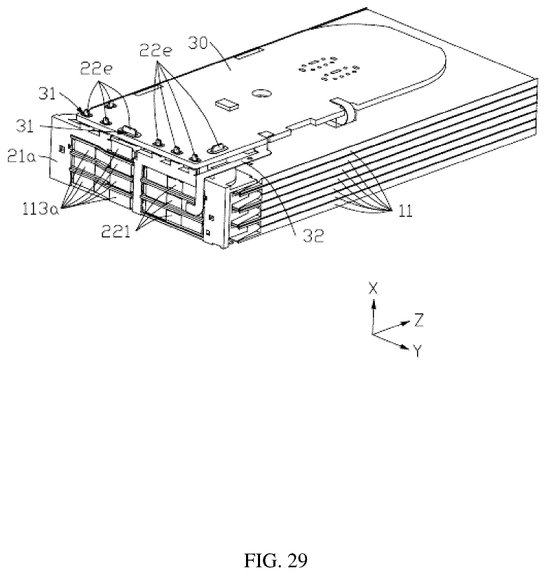

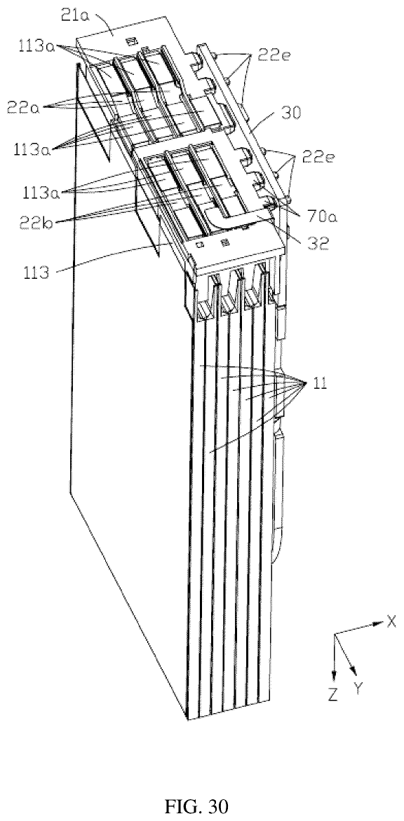

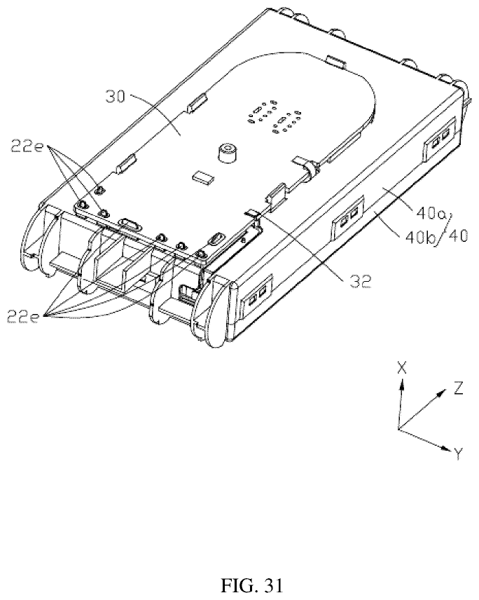

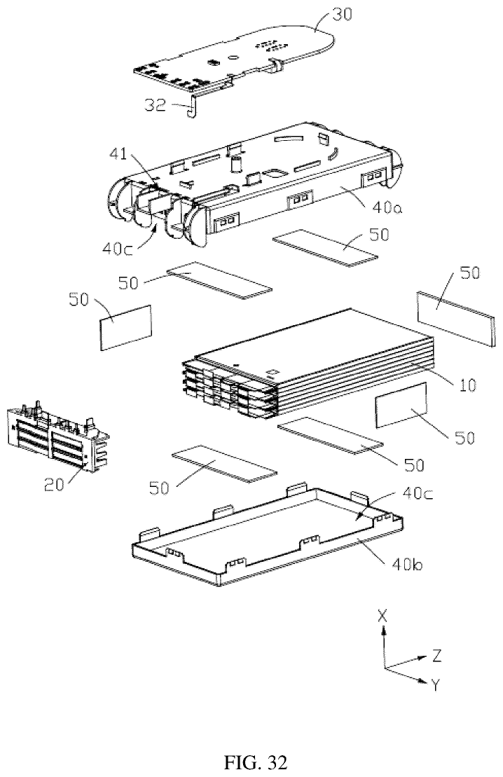

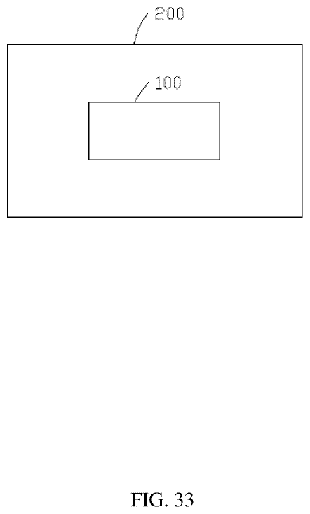

FIG. 16 is a schematic diagram of a front view structure of stacked cells shown in FIG. 15.

FIG. 17 is a schematic structural diagram of a connecting assembly according to some embodiments.

FIG. 18 is a schematic structural diagram of a connecting assembly from another perspective according to some embodiments.

FIG. 19 is a schematic structural diagram of a connecting assembly from yet another perspective according to some embodiments.

FIG. 20 is a schematic structural diagram of a connecting assembly from a further perspective according to some embodiments.

FIG. 21 is a schematic structural diagram of cells and conducting sheets according to some embodiments.

FIG. 22 is a schematic current flow diagram of cells and conducting sheets according to some embodiments.

FIG. 23 is a schematic structural diagram of cells and conducting sheets from another perspective according to some embodiments.

FIG. 24 is a schematic structural diagram of cells and a connecting assembly according to some embodiments.

FIG. 25 is a schematic structural diagram of cells and a connecting assembly from another perspective according to some embodiments.

FIG. 26 is a schematic cross-sectional diagram of cells and a connecting assembly according to some embodiments.

FIG. 27 is a schematic diagram of a side view structure of a connecting assembly according to some embodiments.

FIG. 28 is a schematic cross-sectional diagram of a battery cell assembly according to some embodiments.

FIG. 29 is a schematic structural diagram of a cell assembly, a connecting assembly, and a circuit board according to some embodiments.

FIG. 30 is a schematic structural diagram of a cell assembly, a connecting assembly, and a circuit board from another perspective according to some embodiments.

FIG. 31 is a structural schematic diagram of a battery cell assembly according to some embodiments.

FIG. 32 is an exploded schematic diagram of a battery cell assembly according to some embodiments.

FIG. 33 is a schematic structural diagram of an electric device according to some embodiments.

### REFERENCE SIGNS OF MAIN COMPONENTS

| | |
|---|---|
| Battery cell assembly | 100 |
| Cell assembly | 10 |
| Cell | 11 |
| First cell | 11-a |
| Second cell | 11-b |
| Third cell | 11-c |
| Fourth cell | 11-d |
| Fifth cell | 11-e |
| Sixth cell | 11-f |
| Seventh cell | 11-g |
| Cell housing | 111 |
| First portion | 111a |
| Second portion | 111b |
| First recess | 111c |
| Second recess | 111d |
| First side | 111e |
| Second side | 111f |
| First housing | 1111 |
| Second housing | 1112 |
| First extension part | 1113 |
| Second extension part | 1114 |
| First sealing part | 1115 |
| Second sealing part | 1116 |
| Electrode assembly | 112 |
| First electrode plate | 112a |
| Second electrode plate | 112b |
| Separator | 112c |
| Electrode terminal | 113 |
| Welding part | 113a |
| First terminal | 113b |
| First edge | 1131 |
| Second edge | 1132 |
| Second terminal | 113c |
| Third edge | 1133 |
| Fourth edge | 1134 |
| Connecting assembly | 20 |
| Holder | 21 |
| Substrate | 21a |
| First surface | 201 |
| Second surface | 202 |
| Recess | 211a |
| First protrusion | 211b |
| First recess | 2111 |
| First sub-recess | 2111a |
| Through hole | 211c, 211d |
| First through hole | 2111c |
| Second through hole | 2112c |
| Third through hole | 2111d |
| Fourth through hole | 2112d |
| Fifth through hole | 2111e |
| Second recess | 2112 |
| Second sub-recess | 2112a |
| Third recess | 2113 |
| Second protrusion | 21b |
| First inclined surface | 210b |
| Second inclined surface | 220b |
| First partition | 230b |
| Separation zone | 240b |
| First side edge | 201a |
| First side wall | 210a |
| Second side edge | 202a |
| Second side wall | 220a |
| Fourth recess | 230a |
| Third side edge | 203a |
| third side wall | 2031 |
| Fourth side edge | 204a |
| fourth side wall | 2041 |
| Third protrusion | 240a |
| Fifth gap | 2410 |
| Third inclined surface | 2401 |
| Fourth inclined surface | 2402 |
| Fourth protrusion | 250a |
| Sixth gap | 2510 |
| First protrusion | 205a |
| Second protrusion | 206a |
| Conducting sheet | 22 |
| First conducting sheet | 22a |
| First section | 22a1 |
| Second section | 22a2 |
| First connecting segment | 22a3 |
| First conducting extension | 22a4 |
| part | |
| First connecting part | 22a5 |
| First sub-part | 22a51 |
| Second sub-part | 22a52 |
| Second conducting sheet | 22b |
| Third section | 22b1 |
| Fourth section | 22b2 |
| Second connecting segment | 22b3 |
| Second conducting extension | 22b4 |
| part | |
| Second connecting part | 22b5 |
| Third conducting sheet | 22c |
| Third conducting extension | 22c1 |
| part | |
| Third connecting part | 22c2 |
| Third sub-part | 22c21 |
| Fourth sub-part | 22c22 |
| Fourth conducting sheet | 22d |
| Fourth conducting extension | 22d1 |
| part | |
| Fourth connecting part | 22d2 |
| Conducting extension part | 22e |
| Connecting part | 22f |
| Circuit board | 30 |
| Second hole | 31 |
| Sampling member | 32 |
| Shell | 40 |
| First shell | 40a |
| Second shell | 40b |
| First space | 40c |
| First hole | 41 |
| Insulating member | 50 |
| Electric device | 200 |
| First direction | X |
| Second direction | Y |
| Third direction | Z |

This application will be further described with reference to the accompanying drawings in the following specific embodiments.

### DETAILED DESCRIPTION

The following describes the technical solutions in some embodiments of this application with reference to the accompanying drawings in these embodiments of this application. Apparently, some described embodiments are only some rather than all embodiments of this application.

When a component is deemed as being “disposed” on another component, it may be directly disposed on the another component, or there may be a component in between. When a component is deemed as being “connected to” another component, it may be directly connected to the another component, or there may be a component in between.

It should be understood that the terms “perpendicular” and “equal to” are used for describing an ideal state of two components. During actual production or use, an approximately perpendicular or equal state may be present between the two components. For example, with reference to the description of numerical values, “perpendicular” may indicate that an included angle between two straight lines is within a range of 90°±10°, “perpendicular” may alternatively indicate that a dihedral angle of two planes is within a range of 90°±10°, and “perpendicular” may further alternatively indicate that an included angle between a straight line and a plane is within a range of 90°±10°. Two components described as “perpendicular” to each other may not be absolutely straight lines or planes, and may be approximately straight lines or planes. From a macro perspective, a component can be considered as a “straight line” or “plane” as long as the overall extension direction is a straight line or a plane.

The term “parallel” is used for describing an ideal state of two components. During actual production or use, an approximately parallel state may be present between the two components. For example, with reference to the description of numerical values, “parallel” may indicate that an included angle between two straight lines is within a range of 180°±10°, “parallel” may alternatively indicate that a dihedral angle of two planes is within a range of 180°±10°, and “parallel” may further alternatively indicate that an included angle between a straight line and a plane is within a range of 180°±10°. Two components described as “parallel” to each other may not be absolutely straight lines or planes, and may be approximately straight lines or planes. From a macro perspective, a component can be considered as a “straight line” or “plane” as long as the overall extension direction is a straight line or a plane.

Unless otherwise defined, the term “a plurality of” in the specification specifically indicates that there are two or more components when used for describing the number of components.

Unless otherwise defined, all technical and scientific terms used herein shall have the same meanings as commonly understood by persons skilled in the art to which this application belongs. The terms used herein in the specification of this application are intended to merely describe specific embodiments rather than to limit this application. The term “and/or” used herein includes any and all combinations of one or more related listed items.

An embodiment of this application provides a battery cell assembly including a cell assembly, a holder, and N conducting sheets. The cell assembly includes M cells stacked along a first direction. Each cell includes a cell housing, an electrode terminal, and an electrode assembly disposed within the cell housing. The electrode terminal is connected to the electrode assembly and extends out of the cell housing. A welding part is provided on a portion of the electrode terminal located outside the cell housing. Along the first direction, a projection of the welding part of the each cell is spaced apart from a projection of the welding part of an adjacent cell. The N conducting sheets are disposed on the holder and spaced apart from each. At least a portion of each conducting sheet is exposed through the holder. The electrode terminals pass through the holder. The welding part is connected to the portion of the conducting sheet exposed through the holder. With the welding parts of the electrode terminals of adjacent cells being arranged in a non-overlapping manner in the first direction, the risk of short circuits between the welding parts of the adjacent electrode terminals is reduced, facilitating the connection of the electrode terminals.

An embodiment of this application further provides a battery cell assembly, including a cell assembly and N conducting sheets. The cell assembly includes M cells stacked along a first direction. Each cell includes a cell housing, an electrode terminal, and an electrode assembly disposed within the cell housing. The electrode terminal is connected to the electrode assembly and extends out of the cell housing. A welding part is provided on a portion of the electrode terminal located outside the cell housing. Along the first direction, a projection of the welding part of the each cell is spaced apart from a projection of the welding part of an adjacent cell, and M≥3. Adjacent cells are connected by the conducting sheets, and the welding part is connected to the conducting sheet. With the welding parts of the electrode terminals of adjacent cells being arranged in a non-overlapping manner in the first direction, the risk of short circuits between the welding parts of the adjacent electrode terminals is reduced, facilitating the connection of the electrode terminals.

The following describes in detail some embodiments of this application with reference to the accompanying drawings. In absence of conflicts, the following embodiments and features in these embodiments may be combined.

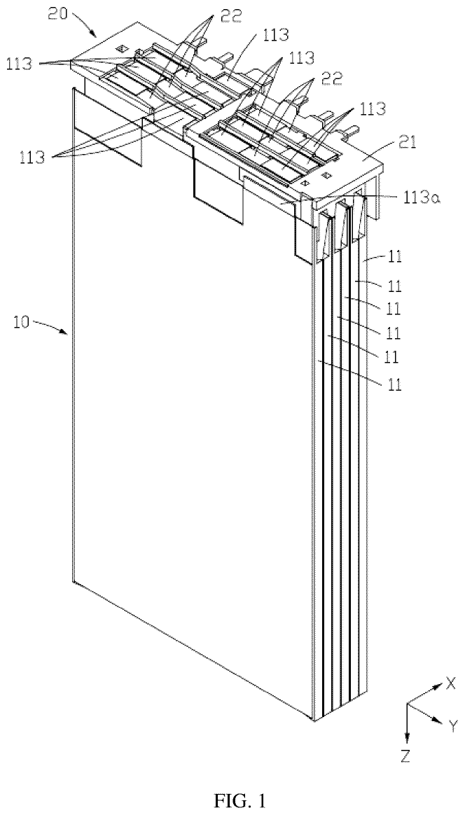

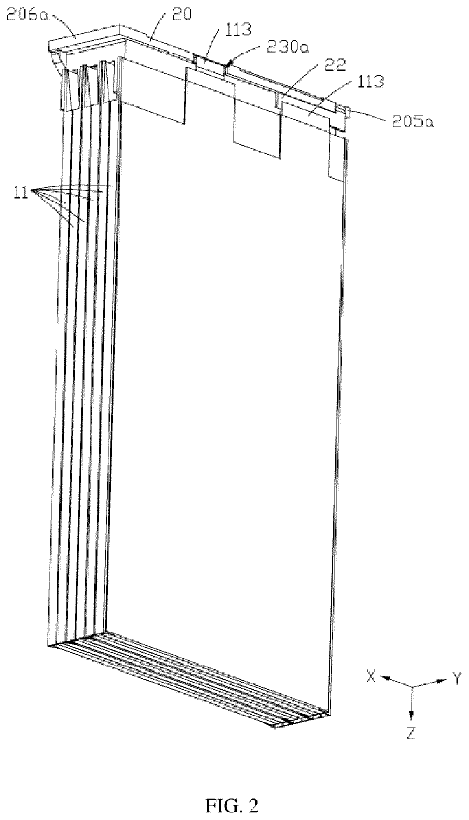

Referring to FIG. 1 to FIG. 5, an embodiment of this application provides a battery cell assembly 100, including a cell assembly 10 and a connecting assembly 20. The cell assembly 10 includes M cells 11 stacked along a first direction X, where M≥3. Each cell 11 includes a cell housing 111, an electrode terminal 113, and an electrode assembly 112 disposed within the cell housing 111. The electrode terminal 113 is connected to the electrode assembly 112 and extends out of the cell housing 111. A welding part 113a is provided on a portion of the electrode terminal 113 located outside the cell housing 111. The electrode terminal 113 includes a first terminal 113b and a second terminal 113c. In this embodiment, the first terminals 113b and the second terminals 113c of even-numbered cells 11 are arranged along a second direction Y, and the second terminals 113c and the first terminals 113b of odd-numbered cells 11 are arranged along the second direction Y. In other embodiments, the first terminals 113b and the second terminals 113c of the odd-numbered cells 11 are arranged along the second direction Y, and the second terminals 113c and the first terminals 113b of the even-numbered cells 11 are arranged along the second direction Y. The first terminal 113b and the second terminal 113c have opposite polarities, one of the first terminal 113b and the second terminal 113c is a positive electrode terminal, and the other is a negative electrode terminal. In this specification, the first terminal 113b is described as a positive electrode terminal, and the second terminal 113c is described as a negative electrode terminal. Along the first direction X, a projection of the welding part 113a of the each cell 11 is spaced apart from a projection of the welding part 113a of an adjacent cell 11. Each electrode terminal 113 is connected to the connecting assembly 20. With the electrode terminals 113 of adjacent cells 11 being arranged in a non-overlapping manner in the first direction X, the risk of short circuits between adjacent electrode terminals 113 is reduced, facilitating the connection with the connecting assembly 20, and a few or no separation elements such as foam need to be provided between the cell housings 111 to increase the distance between adjacent electrode terminals 113. This is conducive to producing thinner battery cell assemblies 100 and improving the energy density of the battery cell assemblies 100. In an embodiment, a thickness of a single cell 11 along the first direction X is 1.5 mm to 4 mm. The thickness of a single cell 11 may be any one of 1.5 mm, 1.6 mm, 1.7 mm, 1.8 mm, 1.9 mm, 2.0 mm, 2.1 mm, 2.2 mm, 2.3 mm, 2.4 mm, 2.5 mm, 2.6 mm, 2.7 mm, 2.8 mm, 2.9 mm, 3.0 mm, 3.1 mm, 3.2 mm, 3.3 mm, 3.4 mm, 3.5 mm, 3.6 mm, 3.7 mm, 3.8 mm, 3.9 mm, and 4.0 mm.

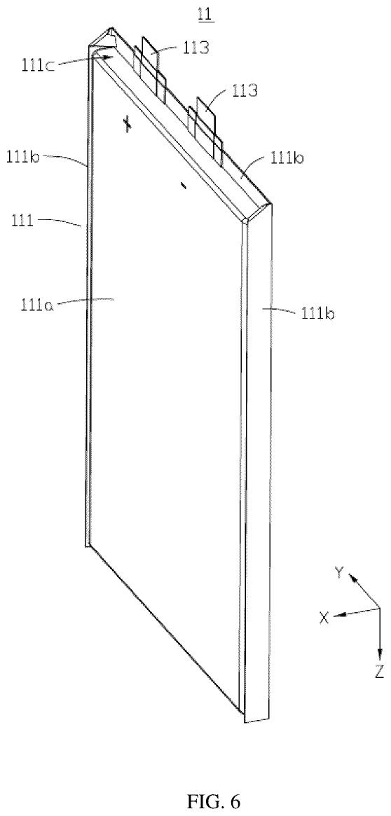

Referring to FIG. 6, in an embodiment, the cell housing 111 includes a first portion 111a and a second portion 111b. The first portion 111a accommodates the electrode assembly 112, the second portion 111b is connected to the first portion 111a, forming a first recess 111c, and the electrode terminal 113 extends out of the second portion 111b. Optionally, the cell housing 111 includes an aluminum-plastic film. Optionally, the cell 11 includes a pouch cell.

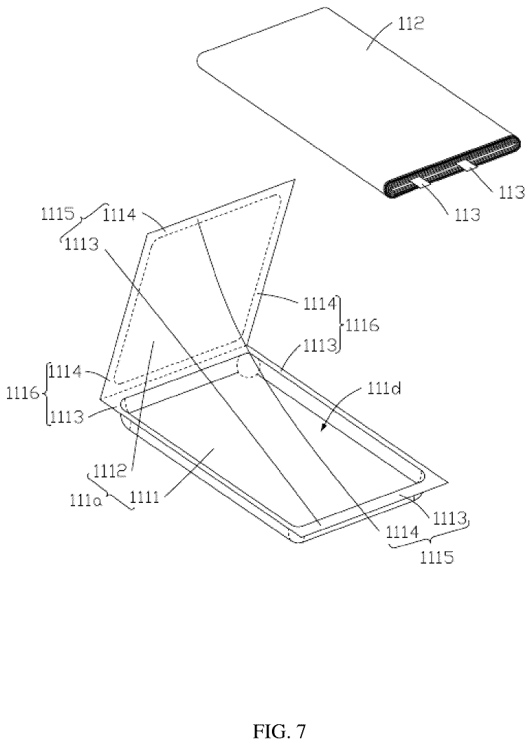

Referring to FIG. 7, in an embodiment, the cell housing 111 includes a first housing 1111 and a second housing 1112, and the first housing 1111 is connected to the second housing 1112. One of the first housing 1111 and the second housing 1112 is provided with a second recess 111d for placing the electrode assembly 112, and the other has a planar structure. The first housing 1111 and the second housing 1112 can be folded along the connection position (dotted line position) so that the first housing 1111 and the second housing 1112 overlap, forming a first portion 111a to cover the electrode assembly 112. The periphery of the first housing 1111 extends outward to form a plurality of first extension parts 1113, and the periphery of the second housing 1112 extends outward to form a plurality of second extension parts 1114. After the first housing 1111 and the second housing 1112 are folded along the connection position, the first extension parts 1113 and the second extension parts 1114 overlap and are hermetically connected, forming a second portion 111b. Optionally, the first extension parts 1113 and the second extension parts 1114 are hermetically connected by sealing adhesive. The second portion 111b includes a first sealing part 1115 and a second sealing part 1116. The first sealing part 1115 is arranged opposite to the connection position, and the electrode terminal 113 extends out of the first sealing part 1115 of the first portion 111a. Optionally, the second portion 111b includes two second sealing parts 1116, and the two second sealing parts 1116 are arranged along the second direction Y. The second direction Y is perpendicular to the first direction X. Optionally, the second portion 111b includes one first sealing part 1115, the cell 11 includes two electrode terminals 113, and the two electrode terminals 113 extend out of the first sealing part 1115 of the cell housing 111. In other embodiments, the first housing 1111 and the second housing 1112 are arranged apart. The second portion 111b includes two first sealing parts 1115, the two first sealing parts 1115 are arranged along the third direction Z. The cell 11 includes two electrode terminals 113, one electrode terminal 113 extends out of the cell housing 111 from one first sealing part 1115, the other electrode terminal 113 extends out of the cell housing 111 from the other first sealing part 1115, and the two electrode terminals 113 are arranged along the third direction Z. The third direction Z is perpendicular to both the first direction X and the second direction Y.

Providing the second recess 111d in one of the first housing 1111 and the second housing 1112 can increase the space of the first recess 111c. When the cells 11 are stacked, the first recesses 111c of adjacent cells 11 communicate, further increasing the space, and along the first direction X, the distance between the electrode terminals 113 of adjacent cells 11 can be increased, reducing the risk of short circuits. In an embodiment, an insulating component (not shown) is provided in the first recess 111c. The insulating component is disposed between the first portion 111a and the connecting assembly 20, further reducing the risk of short circuits between the cell 11 and the connecting assembly 20. Optionally, the insulating component includes foam.

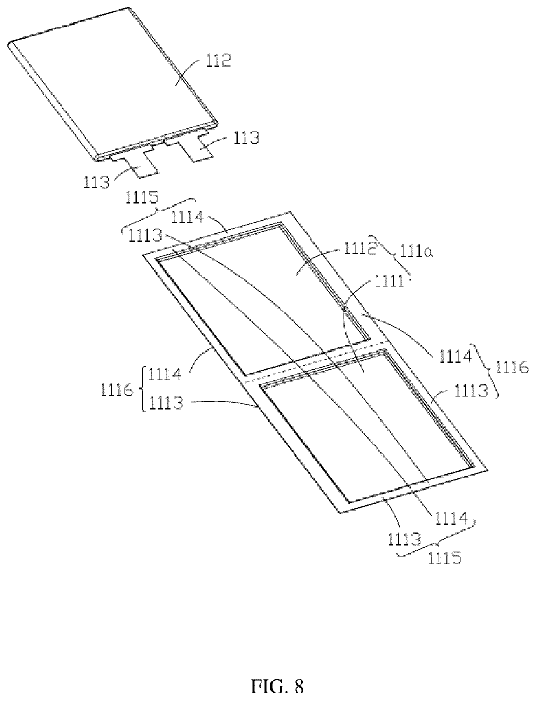

Referring to FIG. 8, in another embodiment, the cell housing 111 includes a first housing 1111 and a second housing 1112, and the first housing 1111 is connected to the second housing 1112. The first housing 1111 and the second housing 1112 are both provided with a second recess 111d, a portion of the electrode assembly 112 is disposed in the second recess 111d of the first housing 1111, and a portion of the electrode assembly 112 is disposed in the second recess 111d of the second housing 1112. Along the first direction X, a first recess 111c is provided on two sides of the second portion 111b.

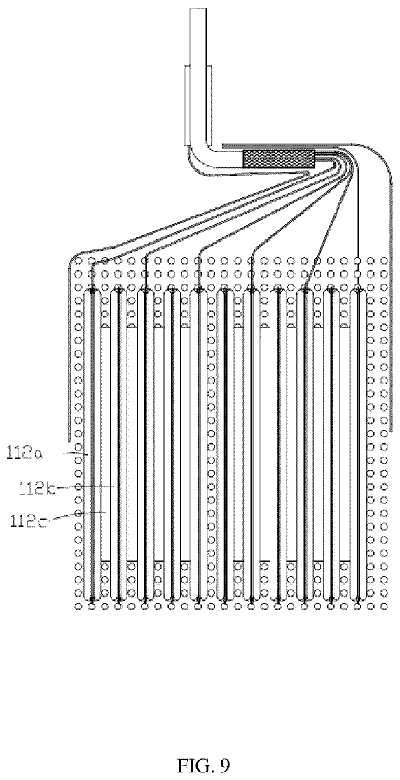

Referring to FIG. 9, in an embodiment, the electrode assembly 112 includes a winding structure formed by stacking and rolling a first electrode plate 112a, a second electrode plate 112b, and a separator 112c. In some other embodiments, the electrode assembly 112 may alternatively be of a laminated structure, and the first electrode plate 112a and the second electrode plate 112b have opposite polarities.

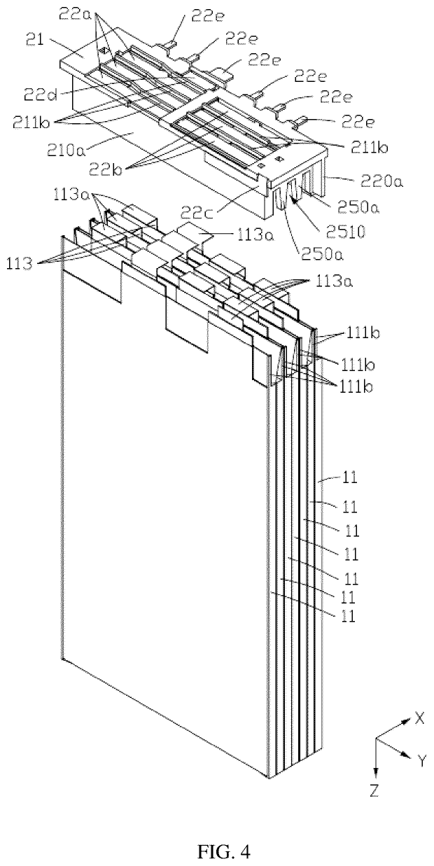

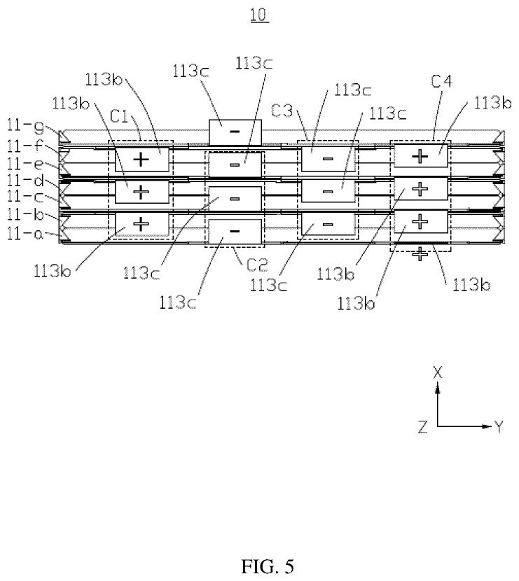

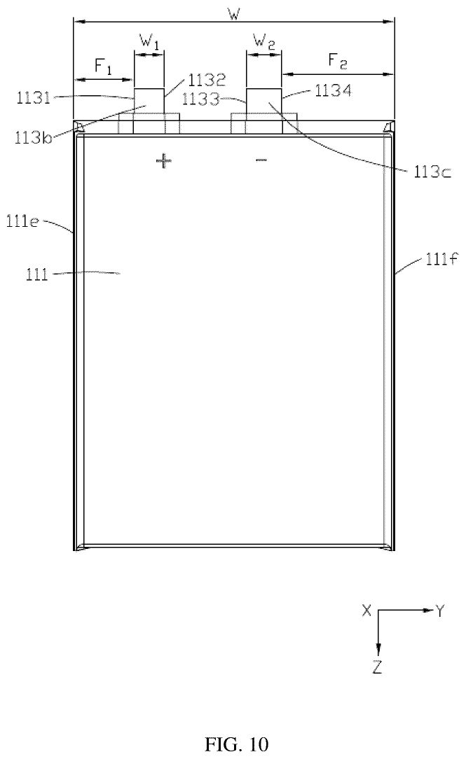

Referring to FIG. 4, FIG. 5, and FIG. 10, in an embodiment, the portion of the electrode terminal 113 located outside the cell housing 111 includes a welding part 113a. Optionally, the welding part 113a may be formed by bending the electrode terminal 113, and the welding part 113a is connected to the connecting assembly 20. Optionally, the welding part 113a is roughly in the shape of a flat plate. The electrode terminal 113 includes a first terminal 113b and a second terminal 113c, the first terminal 113b and the second terminal 113c have opposite polarities, one of the first terminal 113b and the second terminal 113c is a positive electrode terminal, and the other is a negative electrode terminal. Both the first terminal 113b and the second terminal 113c are provided with a welding part 113a.

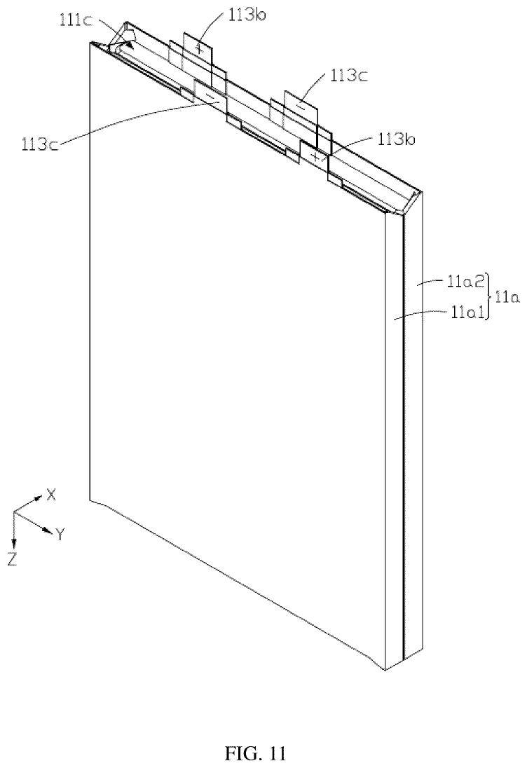

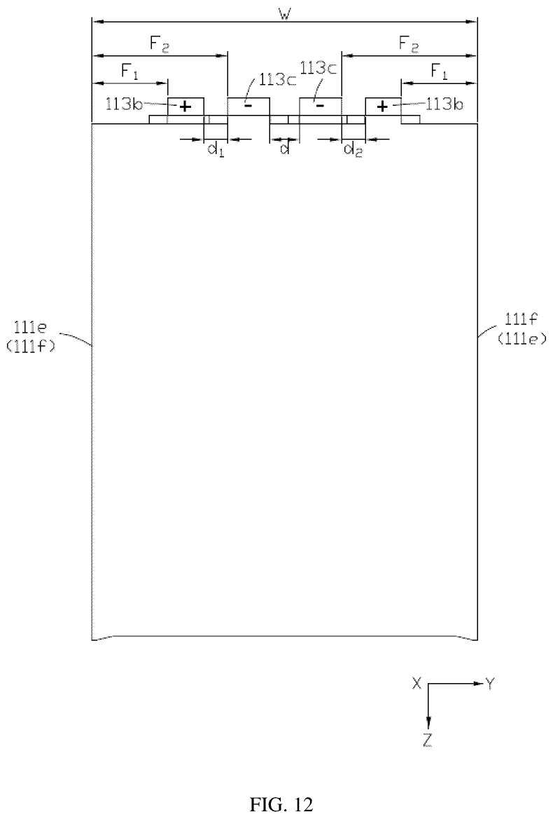

Referring to FIG. 10, FIG. 11, and FIG. 12, in an embodiment, the cell housing 111 includes a first side 111e and a second side 111f arranged along the second direction Y. A distance between the first side 111e and the second side 111f along the second direction Y is width W of the cell 11. The first terminal 113b includes a first edge 1131 and a second edge 1132 arranged along the second direction Y. A distance between the first edge 1131 and the second edge 1132 along the second direction Y is width W₁ of the first terminal 113b, and a distance between the first edge 1131 and the first side 111 along the second direction Y is F₁. The second terminal 113c includes a third edge 1133 and a fourth edge 1134 arranged along the second direction Y. A distance between the third edge 1133 and the fourth edge 1134 along the second direction Y is width W₂ of the second terminal 113c, and a distance between the fourth edge 1134 and the second side 111f along the second direction Y is F₂. F₁ is less than F₂, F₁+W₁<F₂, and 2*(F₂+W₂)<W.

FIG. 12 shows a schematic diagram of two stacked cells 11 with electrode terminals 113 not bent. When viewed along the first direction X, two second terminals 113c are spaced apart, and the two second terminals 113c are located between two first terminals 113b. A distance between opposing edges of the two second terminals 113c along the second direction Y is defined as d, where d=[W−F₁−F₂−2*(W₁+W₂)]/3. When viewed along the first direction X, a distance between opposing edge of one first terminal 113b and the adjacent second terminal 113c is d₁, and a distance between opposing edge of another first terminal 113b and the adjacent second terminal 113c is d₂, where d=d₁=d₂, or d₁ and d₂ are approximately equal to d. The distances between first terminals 113b and second terminals 113c of adjacent cells 11 in the second direction Y are maintained approximately the same, lowering the probability of occurrence of short circuits and reducing the risk of short circuits when the cells 11 are in relatively thin thickness.

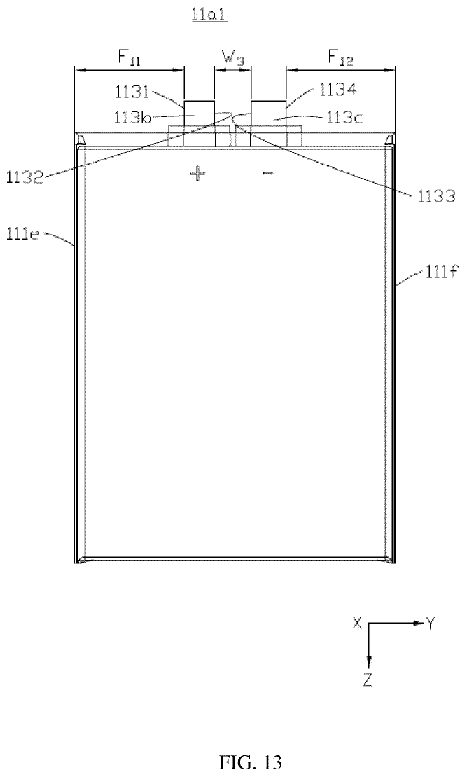

Referring to FIG. 13 to FIG. 16, in another embodiment, electrode terminals 113 of two adjacent cells 11 are arranged at different positions, as illustrated by stacked cells 11a1 and 11a2. For the cell 11a1, a distance between the first edge 1131 and the first side 111e along the second direction Y is F₁₁, a distance between the fourth edge 1134 and the second side 111f along the second direction Y is F₁₂, and a distance between the second edge 1132 and the third edge 1133 along the second direction Y is W₃, where F₁₁=F₁₂, W₃<F₁₁, and W₃<F₁₂.

For the cell 11a2, a distance between the first edge 1131 and the first side 111e along the second direction Y is F₂₁, a distance between the fourth edge 1134 and the second side 111f along the second direction Y is F₂₂, and a distance between the second edge 1132 and the third edge 1133 along the second direction Y is W₄, where F₂₁=F₂₂, W₄>F₁₁, W₄>F₁₁+F₂₁, F₂₁<F₁₁, and W₁+W₂+W₃<W₄.

With two cells 11 stacked, when viewed along the first direction X, the first terminal 113b and the second terminal 113c of the cell 11a1 are located between the first terminal 113b and the second terminal 113c of the cell 11a2. Along the second direction Y, the first terminal 113b of the cell 11a2, the second terminal 113c of the cell 11a1, the first terminal 113b of the cell 11a1, and the second terminal 113c of the cell 11a2 are arranged sequentially and spaced apart. Along the second direction Y, the distance between the first terminal 113b of the cell 11a2 and the second terminal 113c of the cell 11a1 is d₁, the distance between the first terminal 113b of the cell 11a1 and the second terminal 113c of the cell 11a2 is d₂. The distances are equal to or approximately equal to the distance d (W₃) between the first terminal 113b and the second terminal 113c of the cell 11a1, where d=d₁=d₂, or d₁ and d₂ are approximately equal to d. The distances between first terminals 113b and second terminals 113c of adjacent cells 11 are maintained approximately the same in the second direction Y, lowering the probability of occurrence of short circuits and reducing the risk of short circuits when the cells 11 are in relatively thin thickness.

Referring to FIG. 4, FIG. 17, FIG. 21, and FIG. 22, the connecting assembly 20 includes a holder 21 and N conducting sheets 22. The N conducting sheets 22 are disponsed on the holder 21 and paced apart from each, a portion of each conducting sheet 22 is exposed from the holder 21, and the electrode terminal 113 is connected to the conducting sheet 22. Optionally, the welding part 113a is connected to the conducting sheet 22.

In an embodiment, the holder 21 includes an insulating material. Optionally, the surface of the holder 21 includes an insulating material. Optionally, the holder 21 is made of an insulating material, such as formed by an injection molding process.

In an embodiment, a plurality of conducting sheets 22 may be fixed to the holder 21 by means of snap-fits, adhesive substances, fasteners, and the like.

In an embodiment, the N conducting sheets 22 are embedded in the holder 21. For example, a plurality of conducting sheets 22 are embedded in the holder 21 by an injection molding process.

In an embodiment, the N conducting sheets 22 include NI first conducting sheets 22a, and the first conducting sheets 22a may be configured to connect adjacent cells 11. In this specification, N1=3 is used as an example for illustration.

In an embodiment, the N conducting sheets 22 include N2 second conducting sheets 22b, and the second conducting sheets 22b may be configured to connect adjacent cells 11. The N1 first conducting sheets 22a and the N2 second conducting sheets 22b are spaced apart. In this specification, N2=3 is used as an example for illustration.

In an embodiment, the N conducting sheets 22 include N3 third conducting sheets 22c, and the third conducting sheets 22c are connected to the cells 11 and serve as an overall positive connection terminal for the M cells 11 for input or output of electric energy. In this specification, N3=1 is used as an example for illustration.

In an embodiment, the N conducting sheets 22 include N4 fourth conducting sheets 22d, and the fourth conducting sheets 22d are connected to the cells 11 and serve as an overall negative connection terminal for the M cells 11 for input or output of electric energy. In this specification, N4=1 is used as an example for illustration.

In an embodiment, N=N1+N2+N3=M+1. In an embodiment, N=M+1. In some embodiments, M≥5. In this specification, M=7 and N=8 are used as an example for illustration. In an embodiment, M=6, N=7.

In an embodiment, the second terminal 113c of any cell 11 between the first cell 11 and the M-th cell 11 and the first terminal 113b of an adjacent cell 11 are connected to a same conducting sheet 22 to achieve series connection. In other embodiments, adjacent cells 11 may be connected in parallel.

In an embodiment, when M is an odd number, the first terminal 113b of the first cell 11 serves as a first output terminal of the cell assembly 10, and the second terminal 113c of the M-th cell 11 serves as a second output terminal of the cell assembly 10. When viewed along the third direction Z, along the first direction X, the welding part 113a of the second terminal 113c of the first cell 11 and the welding part 113a of the first terminal 113b of the second cell 11 are connected to a same first conducting sheet 22a, and the welding part 113a of the second terminal 113c of the first cell 11 and the welding parts 113a of the second terminals 113c of other odd-numbered cells 11 are spaced apart from each other. The welding part 113a of the first terminal 113b of the M-th cell 11 and the welding parts 113a of the first terminals 113b of other odd-numbered cells 11 are spaced apart from each other.

Referring to FIG. 22, when M is an odd number, in this specification, M=7 and N=8 are used as an example for illustration. The 7 cells 11 include a first cell 11-a, a second cell 11-b, a third cell 11-c, a fourth cell 11-d, a fifth cell 11-e, a sixth cell 11-f, and a seventh cell 11-g stacked along the first direction X. The welding part 113a of the first terminal 113b of the first cell 11-a is connected to a third conducting sheet 22c as an overall positive output terminal of the cell assembly 10, and the welding part 113a of the second terminal 113c of the seventh cell 11-g is connected to the fourth conducting sheet 22d as an overall negative output terminal of the cell assembly 10. The welding part 113a of the second terminal 113c of the first cell 11-a and the welding part 113a of the first terminal 113b of the second cell 11-b are connected to a same first conducting sheet 22a. The welding part 113a of the second terminal 113c of the second cell 11-b and the welding part 113a of the first terminal 113b of the third cell 11-c are connected to a same second conducting sheet 22b. The welding part 113a of the second terminal 113c of the third cell 11-c and the welding part 113a of the first terminal 113b of the fourth cell 11-d are connected to a same first conducting sheet 22a. The welding part 113a of the second terminal 113c of the fourth cell 11-d and the welding part 113a of the first terminal 113b of the fifth cell 11-e are connected to a same second conducting sheet 22b. The welding part 113a of the second terminal 113c of the fifth cell 11-e and the welding part 113a of the first terminal 113b of the sixth cell 11-f are connected to a same first conducting sheet 22a. The welding part 113a of the second terminal 113c of the sixth cell 11-f and the welding part 113a of the first terminal 113b of the seventh cell 11-g are connected to a same second conducting sheet 22b. The welding part 113a of the second terminal 113c of the first cell 11-a, the welding part 113a of the second terminal 113c of the third cell 11-c, the welding part 113a of the second terminal 113c of the fifth cell 11-e, and the welding part 113a of the second terminal 113c of the seventh cell 11-g are spaced apart along the first direction X.

In an embodiment, when M is an even number, the first terminal 113b of the first cell 11 serves as a first output terminal of the cell assembly 10, and the second terminal 113c of the M-th cell 11 serves as a second output terminal of the cell assembly 10. When viewed along the third direction Z, along the first direction X, the welding part 113a of the second terminal 113c of the first cell 11 and the welding part 113a of the first terminal 113b of the second cell 11 are connected by a same conducting sheet 22, the welding part 113a of the second terminal 113c of the first cell 11 and the welding parts 113a of the second terminals 113c of other odd-numbered cells 11 are spaced apart from each other, and the welding part 113a of the second terminal 113c of the M-th cell 11 and the welding parts 113a of the second terminals 113c of other even-numbered cells 11 are spaced apart from each other.

Referring to FIG. 23, when M is an even number, in this specification, M=6 and N=7 are used as an example for illustration. The figure only shows the welding parts 113a of 6 cells. The 6 cells 11 include a first cell 11-a, a second cell 11-b, a third cell 11-c, a fourth cell 11-d, a fifth cell 11-e, and a sixth cell 11-f stacked along the first direction X. The welding part 113a of the first terminal 113b of the first cell 11-a is connected to the third conducting sheet 22c as an overall positive output terminal of the cell assembly 10, and the welding part 113a of the second terminal 113c of the sixth cell 11-f is connected to the fourth conducting sheet 22d as an overall negative output terminal of the cell assembly 10. The welding part 113a of the second terminal 113c of the first cell 11-a and the welding part 113a of the first terminal 113b of the second cell 11-b are connected to a same second conducting sheet 22b. The welding part 113a of the second terminal 113c of the second cell 11-b and the welding part 113a of the first terminal 113b of the third cell 11-c are connected to a same first conducting sheet 22a. The welding part 113a of the second terminal 113c of the third cell 11-c and the welding part 113a of the first terminal 113b of the fourth cell 11-d are connected to a same second conducting sheet 22b. The welding part 113a of the second terminal 113c of the fourth cell 11-d and the welding part 113a of the first terminal 113b of the fifth cell 11-e are connected to a same first conducting sheet 22a. The welding part 113a of the second terminal 113c of the fifth cell 11-e and the welding part 113a of the first terminal 113b of the sixth cell 11-f are connected to a same second conducting sheet 22b. The welding part 113a of the second terminal 113c of the first cell 11-a, the welding part 113a of the second terminal 113c of the third cell 11-c, and the welding part 113a of the second terminal 113c of the fifth cell 11-e are spaced apart along the first direction X. The welding part 113a of the second terminal 113c of the second cell 11-b, the welding part 113a of of first terminal 113b of the fourth cell 11-d, and the welding part 113a of the second terminal 113c of the sixth cell 11-f are spaced apart along the first direction X.

In an embodiment, when viewed along the third direction Z, along the first direction X, the welding parts 113a of the first cell 11 to the (M−1)-th cell 11 are arranged in groups, where the welding parts 113a of the first terminals 113b of even-numbered cells 11 are spaced apart from each other to form a first group C1, the welding parts 113a of the second terminals 113c of odd-numbered cells 11 are spaced apart from each other to form a second group C2, the welding parts 113a of the second terminals 113c of the even-numbered cells 11 are spaced apart from each other to form a third group C3, and the welding parts 113a of the first terminals 113b of the odd-numbered cells 11 are spaced apart from each other to form a fourth group C4. Along the second direction Y, the first group C1, the second group C2, the third group C3, and the fourth group C4 are arranged sequentially and spaced apart. Utilizing the space of the M cells 11 along the second direction Y increases the volume of the battery cell assembly 100, reducing the risk of short circuits between the cells 11.

In some embodiments, optionally, along the first direction X, projections of the welding parts 113a of the first terminals 113b of the even-numbered cells 11 overlap. Optionally, along the first direction X, projections of the welding parts 113a of the second terminals 113c of the odd-numbered cells 11 overlap. Optionally, projections of the welding parts 113a of the second terminals 113c of the even-numbered cells 11 overlap. Optionally, projections of the welding parts 113a of the first terminals 113b of the odd-numbered cells 11 overlap.

Referring to FIG. 22, in this specification, M=7 and N=8 are used as an example for illustration. The welding part 113a of the first terminal 113b of the second cell 11-b, the welding part 113a of the first terminal 113b of the fourth cell 11-d, and the welding part 113a of the first terminal 113b of the sixth cell 11-f are spaced apart from each other along the first direction X to form a first group C1.

The welding part 113a of the second terminal 113c of the first cell 11-a, the welding part 113a of the second terminal 113c of the third cell 11-c, and the welding part 113a of the second terminal 113c of the fifth cell 11-e are spaced apart from each other along the first direction X to form a second group C2, and the first group C1 and the second group C2 are spaced apart along the second direction Y.

The welding part 113a of the second terminal 113c of the second cell 11-b, the welding part 113a of the second terminal 113c of the fourth cell 11-d, and the welding part 113a of the second terminal 113c of the sixth cell 11-f are spaced apart from each other along the first direction X to form a third group C3, and the second group C2 and the third group C3 are spaced apart along the second direction Y.

The welding part 113a of the first terminal 113b of the first cell 11-a, the welding part 113a of the first terminal 113b of the third cell 11-c, and the welding part 113a of the first terminal 113b of the fifth cell 11-e are spaced apart from each other along the first direction X to form a fourth group C4, and the third group C3 and the fourth group C4 are spaced apart along the second direction Y.

In an embodiment, along the first direction X, the projections of the welding parts 113a of each cell 11 substantially overlap. For example, along the first direction X, the projections of the welding parts 113a of the cells 11 in the first group C1 substantially overlap.

Referring to FIG. 22, in an embodiment, the first terminal 113b of the first cell 11 serves as an overall output terminal of the cell assembly 10, and the second terminal 113c of the M-th cell serves as another overall output terminal of the cell assembly 10. Optionally, the first terminal 113b serves as a positive electrode terminal, and the second terminal 113c serves as a negative electrode terminal. When viewed along the third direction Z, along the first direction X, the welding part 113a of the second terminal 113c of the first cell 11 and the welding part 113a of the first terminal 113b of the second cell 11 are connected by a first conducting sheet 22a, the welding part 113a of the second terminal 113c of the first cell 11 and the welding parts 113a of the second terminals 113c of other odd-numbered cells 11 are spaced apart from each other to form the second group C2. Specifically, using M=7 and N=8 as an example for illustration, the welding part 113a of the second terminal 113c of the first cell 11-a, the welding part 113a of the second terminal 113c of the third cell 11-c, the welding part 113a of the second terminal 113c of the fifth cell 11-e, and the welding part 113a of the second terminal 113c of the seventh cell 11-g are spaced apart from each other along the first direction X to form the second group C2.

Referring to FIG. 17 to FIG. 22, in an embodiment, the holder 21 includes a substrate 21a. The substrate 21a includes a first surface 201 and a second surface 202 disposed along the third direction Z. The first surface 201 is provided with a recess 211a, a portion of the conducting sheet 22 is exposed from the recess 211a, and the electrode terminals 113 pass through the substrate 21a and are connected to the conducting sheets 22. Optionally, the first conducting sheets 22a, the second conducting sheets 22b, and the fourth conducting sheets 22d are exposed from the recess 211a.

In an embodiment, the recess 211a includes a first recess 2111 and a second recess 2112, the first recess 2111 and the second recess 2112 are spaced apart along the second direction Y. One of the electrode terminals 113 of any cell 11 between the first cell 11 and the M-th cell 11 is disposed on the first recess 2111, and the other electrode terminal 113 is disposed on the second recess 2112. Optionally, the first terminal 113b of a same cell 11 is disposed on the first recess 2111, and the second terminal 113c thereof is disposed on the second recess 2112. Optionally, the second terminal 113c of a same cell 11 is disposed on the first recess 2111, and the first terminal 113b thereof is disposed on the second recess 2112.

In an embodiment, when the number of cells 11 is odd, each first conducting sheet 22a includes a first section 22a1 and a second section 22a2, and the first section 22a1 and the second section 22a2 are disposed along the second direction Y in the first recess 2111. First sections 22a1 of the NI first conducting sheets 22a are spaced apart along the first direction X. The first section 22a1 is configured to connect the welding parts 113a of the second terminals 113c of the odd-numbered cells 11 in the first recess 2111. Along the third direction Z, projections of the first sections 22a1 overlap with projections of the welding parts 113a of the second terminals 113c of the odd-numbered cells 11. Second sections 22a2 of the NI first conducting sheets 22a are spaced apart along the first direction X. The second section 22a2 is configured to connect the welding parts 113a of the first terminals 113b of the even-numbered cells 11 in the first recess 2111. Along the third direction Z, projections of the second sections 22a2 overlap with projections of the welding parts 113a of the first terminals 113b of the even-numbered cells 11.

Specifically, using M=7 and N=8 as an example for illustration, the welding part 113a of the second terminal 113c of the first cell 11-a is connected to the first section 22a1. The welding part 113a of the second terminal 113c of the third cell 11-c is connected to the first section 22a1 of another first conducting sheet 22a. The welding part 113a of the second terminal 113c of the fifth cell 11-e is connected to the first section 22a1 of yet another first conducting sheet 22a.

The welding part 113a of the first terminal 113b of the second cell 11-b is connected to the second section 22a2 of the first conducting sheet 22a connected to the first cell 11-a. The welding part 113a of the first terminal 113b of the fourth cell 11-d is connected to the second section 22a2 of the first conducting sheet 22a connected to the third cell 11-c. The welding part 113a of the first terminal 113b of the sixth cell 11-f is connected to the second section 22a2 of the first conducting sheet 22a connected to the fifth cell 11-e.

In an embodiment, the recess 211a includes a third recess 2113, the first recess 2111 and the third recess 2113 are spaced apart along the first direction X, the fourth conducting sheet 22d is disposed on the third recess 2113 and is exposed from the third recess 2113. The welding part 113a of the second terminal 113c of the M-th cell 11 is connected to the fourth conducting sheet 22d for input or output of electric energy, for example, as an overall positive connection terminal or an overall negative connection terminal.

In an embodiment, when viewed along the third direction Z, along the first direction X, the welding part 113a of the second terminal 113c of the M-th cell 11 and the welding parts 113a of the second terminals 113c of the odd-numbered cells 11 are spaced apart. Specifically, using M=7 and N=8 as an example for illustration, the welding part 113a of the second terminal 113c of the first cell 11-a, the welding part 113a of the second terminal 113c of the third cell 11-c, the welding part 113a of the second terminal 113c of the fifth cell 11-e, and the welding part 113a of the second terminal 113c of the seventh cell 11 are arranged sequentially and spaced apart along the first direction X. Optionally, the welding part 113a of the second terminal 113c of the seventh cell 11 is connected to the fourth conducting sheet 22d for input or output of electric energy, for example, as an overall negative connection terminal.

In an embodiment, when viewed along the third direction Z, along the first direction X, the welding part 113a of the first terminal 113b of the first cell 11 and the welding parts 113a of the first terminals 113b of the odd-numbered cells 11 are spaced apart. Specifically, using M=7 and N=8 as an example for illustration, the welding part 113a of the first terminal 113b of the first cell 11-a, the welding part 113a of the first terminal 113b of the third cell 11-c, the welding part 113a of the first terminal 113b of the fifth cell 11-e, and the welding part 113a of the first terminal 113b of the seventh cell 11 are arranged sequentially and spaced apart along the first direction X. Optionally, the welding part 113a of the first terminal 113b of the first cell 11 is connected to the third conducting sheet 22c for input or output of electric energy, for example, as an overall positive connection terminal.

In an embodiment, along the first direction X, the first section 22a1 of a same first conducting sheet 22a is closer to the first cell 11 than the second section 22a2, so that the second section 22a2 of a first conducting sheet 22a is closer to the M-th cell 11 than the first section 22a1. By shifting the first section 22a1 in the first recess 2111 away from the third recess 2113, the area of the third recess 2113 is increased, thus increasing the welding area between the fourth conducting sheet 22d in the third recess 2113 and the welding part 113a of the second terminal 113c of the M-th cell 11. Optionally, the welding area between the fourth conducting sheet 22d and the welding part 113a is equal to the welding area between the first section 22al and the welding part 113a, and the welding area between the fourth conducting sheet 22d and the welding part 113a is equal to the welding area between the second section 22a2 and the welding part 113a. This improves the consistency of the individual cells 11.

Specifically, using M=7, N=8, the fifth cell 11-e, and the sixth cell 11-f as an example for illustration, the welding part 113a of the second terminal 113c of the fifth cell 11-e and the welding part 113a of the first terminal 113b of the sixth cell 11-f are connected to a same first conducting sheet 22a, the welding part 113a of the second terminal 113c of the fifth cell 11-e is connected to the first section 22a1, and the welding part 113a of the first terminal 113b of the sixth cell 11-f is connected to the second section 22a2. When viewed along the third direction Z, along the first direction X, a distance between the first section 22a1 and the first cell 11-a is less than a distance between the second section 22a2 and the first cell 11-a. Along the first direction X, a distance D1 between the second section 22a2 and the fourth conducting sheet 22d is less than a distance D2 between the first section 22a1 and the fourth conducting sheet 22d.

In an embodiment, each first conducting sheet 22a further includes a first connecting segment 22a3. The first connecting segment 22a3 is connected to the first section 22a1 and the second section 22a2 of a same first conducting sheet 22a. The first connecting segment 22a3 is arranged at a first angle α with respect to the first direction X. The first angle α is an obtuse angle, so that the first section 22a1 of a same first conducting sheet 22a is closer to the first cell 11 than the second section 22a2.

In an embodiment, the second conducting sheet 22b includes a third section 22b1 and a fourth section 22b2 arranged along the second direction Y. The third sections 22b1 of the N2 second conducting sheets 22b are spaced apart along the first direction X. The third section 22b1 is configured to connect the welding parts 113a of the second terminals 113c of even-numbered cells 11 in the second recess 2112. Along the third direction Z, projections of the third sections 22b1 overlap with projections of the welding parts 113a of the second terminals 113c of the even-numbered cells 11. The fourth sections 22b2 of the N2 second conducting sheets 22b are spaced apart along the first direction X. The fourth section 22b2 is configured to connect the welding parts 113a of the first terminals 113b of odd-numbered cells 11 in the second recess 2112. Along the third direction Z, projections of the fourth sections 22b2 overlap with projections of the welding parts 113a of the first terminals 113b of the odd-numbered cells 11.

Specifically, using M=7 and N=8 as an example for illustration, the welding part 113a of the second terminal 113c of the second cell 11-b is connected to the third section 22b1. The welding part 113a of the second terminal 113c of the fourth cell 11-d is connected to the third section 22b1 of another second conducting sheet 22b. The welding part 113a of the second terminal 113c of the sixth cell 11-f is connected to the third section 22b1 of yet another second conducting sheet 22b.

The welding part 113a of the first terminal 113b of the third cell 11-c is connected to the fourth section 22b2 of the second conducting sheet 22b connected to the second cell 11-b. The welding part 113a of the first terminal 113b of the fifth cell 11-e is connected to the fourth section 22b2 of the second conducting sheet 22b connected to the fourth cell 11-d. The welding part 113a of the first terminal 113b of the seventh cell 11-e is connected to the fourth section 22b2 of the second conducting sheet 22b connected to the sixth cell 11-e.

In an embodiment, the second conducting sheet 22b further includes a second connecting segment 22b3. The second connecting segment 22b3 is connected to a third section 22b1 and a fourth section 22b2 of a same second conducting sheet 22b. Optionally, the second connecting segment 22b3 extends along the second direction Y.

In an embodiment, along the first direction X, a distance from the third section 22b1 to the first cell 11 is equal to a distance from the fourth section 22b2 of a same second conducting sheet 22b to the first cell 11. Specifically, using M=7 and N=8 as an example for illustration, along the first direction X, a distance from a third section 22b1 connected to the welding part 113a of the second terminal 113c of the second cell 11-b to the first cell 11-a is equal to a distance from the fourth section 22b2 connected to the welding part 113a of the first terminal 113b of the third cell 11-c to the first cell 11-a.

In an embodiment, the second section 22a2, the first section 22a1, the third section 22b1, and the fourth section 22b2 are arranged sequentially along the second direction Y. Along the second direction Y, the first section 22a1 and the third section 22b1 are located between the second section 22a2 and the fourth section 22b2. Specifically, using M=7 and N=8 as an example for illustration, the welding part 113a of the second terminal 111c of the first cell 11-a is connected to the first section 22a1, the welding part 113a of the first terminal 113b of the second cell 11-b is connected to the second section 22a2, the welding part 113a of the second terminal 113c of the second cell 11-b is connected to the third section 22b1, and the welding part 113a of the first terminal 113b of the third cell 11-c is connected to the fourth section 22b2. When viewed along the third direction Z, along the second direction Y, the second section 22a2 and the fourth section 22b2 are arranged, the first section 22a1 and the third section 22b1 are arranged, and the first section 22a1 and the third section 22b1 are located between the second section 22a2 and the fourth section 22b2.

In an embodiment, along the first direction X, a distance from the second section 22a2 to the first cell 11 is equal to a distance from the fourth section 22b2 to the first cell 11. Specifically, using M=7 and N=8 as an example for illustration, along the first direction X, a distance from the second section 22a2 connected to the welding part 113a of the first terminal 113c of the second cell 11-b to the first cell 11-a is equal to a distance from the fourth section 22b2 connected to the welding part 113a of the first terminal 113b of the third cell 11-c to the first cell 11-a.

In an embodiment, along the first direction X, the widths of the first section 22a1, the second section 22a2, the third section 22b1, and the fourth section 22b2 are the same. Optionally, along the first direction X, the width of the welding part 113a is greater than a width of the first section 22a1, the width of the welding part 113a is greater than a width of the second section 22a2, the width of the welding part 113a is greater than a width of the third section 22b1, the width of the welding part 113a is greater than a width of the fourth section 22b2. The welding part 113a is set to be wider than the first section 22a1, the second section 22a2, the third section 22b1, and the fourth section 22b2, ensuring that the connection area between each welding part 113a and the first conducting sheet 22a, as well as between each welding part 113a and the second conducting sheet 22b, is the same, improving the consistency of individual cells 11.

In an embodiment, when the number of cells 11 is even, each first conducting sheet 22a includes a first section 22a1 and a second section 22a2, and the first section 22a1 and the second section 22a2 are arranged along the second direction Y. Optionally, the first section 22a1 and the second section 22a2 are disposed on the second recess 2112. First sections 22al of the NI first conducting sheets 22a are spaced apart along the first direction X. The first section 22a1 is configured to connect the welding parts 113a of the second terminals 113c of the even-numbered cells 11. Along the third direction Z, projections of the first sections 22al overlap with projections of the welding parts 113a of the second terminals 113c of the even-numbered cells 11. Second sections 22a2 of the NI first conducting sheets 22a are spaced apart along the first direction X. The second section 22a2 is configured to connect the welding parts 113a of the first terminals 113b of the odd-numbered cells 11. Along the third direction Z, projections of the second sections 22a2 overlap with projections of the welding parts 113a of the first terminals 113b of the odd-numbered cells 11.

Using M=6 and N=7 as an example for illustration, the welding part 113a of the second terminal 113c of the second cell 11-b is connected to the first section 22a1. The welding part 113a of the second terminal 113c of the fourth cell 11-d is connected to the first section 22a1 of another first conducting sheet 22a.

The welding part 113a of the first terminal 113b of the third cell 11-c is connected to the second section 22a2 of the first conducting sheet 22a connected to the second cell 11-b. The welding part 113a of the first terminal 113b of the fifth cell 11-e is connected to the second section 22a2 of the first conducting sheet 22a connected to the fourth cell 11-d.

In an embodiment, when viewed along the third direction Z, along the first direction X, the welding part 113a of the second terminal 113c of the M-th cell 11 and the welding parts 113a of the second terminals 113c of the even-numbered cells 11 are spaced apart. Specifically, using M=6 and N=7 as an example for illustration, the welding part 113a of the second terminal 113c of the second cell 11-b, the welding part 113a of the second terminal 113c of the fourth cell 11-d, and the welding part 113a of the second terminal 113c of the sixth cell 11-f are arranged sequentially and spaced apart along the first direction X. Optionally, the welding part 113a of the second terminal 113c of the sixth cell 11-f is connected to the fourth conducting sheet 22d for input or output of electric energy, for example, as an overall negative connection terminal.

In an embodiment, when viewed along the third direction Z, along the first direction X, the welding part 113a of the first terminal 113b of the first cell 11 and the welding parts 113a of the first terminals 113b of the odd-numbered cells 11 are spaced apart.

Using M=6 and N=7 as an example for illustration, the welding part 113a of the first terminal 113b of the first cell 11-a, the welding part 113a of the first terminal 113b of the third cell 11-c, and the welding part 113a of the first terminal 113b of the fifth cell 11-e are arranged sequentially and spaced apart along the first direction X. Optionally, the welding part 113a of the first terminal 113b of the first cell 11 is connected to the second section 22a2 for input or output of electric energy, for example, as an overall positive connection terminal. Optionally, the welding part 113a of the first terminal 113b of the first cell 11 is connected to the third conducting sheet 22c for input or output of electric energy, for example, as an overall positive connection terminal. In an embodiment, along the first direction X, a distance from the first section 22a1 to the first cell 11 is less than a distance from the second section 22a2 of a same first conducting sheet 22a to the first cell 11.

In an embodiment, the second conducting sheet 22b includes a third section 22b1 and a fourth section 22b2. The fourth section 22b2 and the third section 22b1 are arranged along the second direction Y. The third sections 22b1 of the N2 second conducting sheets 22b are spaced apart along the first direction X. The third section 22b1 is configured to connect the welding parts 113a of the second terminals 113c of the odd-numbered cells 11. Along the third direction Z, projections of the third sections 22b1 overlap with projections of the welding parts 113a of the second terminals 113c of the odd-numbered cells 11. The fourth sections 22b2 of the N2 second conducting sheets 22b are spaced apart along the first direction X. The fourth section 22b2 is configured to connect the welding parts 113a of the first terminals 113b of the even-numbered cells 11. Along the third direction Z, projections of the fourth sections 22b2 overlap with projections of the welding parts 113a of the first terminals 113b of the even-numbered cells 11.

Using M=6 and N=7 as an example for illustration, the welding part 113a of the second terminal 113c of the first cell 11-a is connected to the third section 22b1. The welding part 113a of the second terminal 113c of the third cell 11-c is connected to the third section 22b1 of another second conducting sheet 22a. The welding part 113a of the second terminal 113c of the fifth cell 11-e is connected to the third section 22b1 of yet another second conducting sheet 22b. The welding part 113a of the first terminal 113b of the second cell 11-b is connected to the fourth section 22b2 of the second conducting sheet 22b connected to the first cell 11-a. The welding part 113a of the first terminal 113b of the fourth cell 11-d is connected to the fourth section 22b2 of the second conducting sheet 22b connected to the third cell 11-c. The welding part 113a of the first terminal 113b of the sixth cell 11-f is connected to the fourth section 22b2 of the second conducting sheet 22b connected to the fifth cell 11-e. In an embodiment, when viewed along the third direction Z, along the first direction X, a distance from the third section 22b1 to the first cell 11 is equal to a distance from the fourth section 22b2 to the first cell 11.

In an embodiment, when viewed along the third direction Z, along the first direction X, a distance from the third section 22b1 to the first cell 11 is equal to a distance from the second section 22a2 to the first cell 11. Specifically, using M=6 and N=7 as an example for illustration, along the first direction X, a distance from the second section 22a2 connected to the welding part 113a of the first terminal 113b of the first cell 11-a to the first cell 11-a is equal to a distance from the third section 22b1 connected to the welding part 113a of the second terminal 113c of the first cell 11-a to the first cell 11-a.

In an embodiment, the fourth section 22b2, the third section 22b1, the first section 22a1, and the second section 22a2 are arranged sequentially along the second direction Y. Along the second direction Y, the third section 22b1 and the first section 22a1 are located between the fourth section 22b2 and the second section 22a2. Specifically, using M=6 and N=7 as an example for illustration, the welding part 113a of the second terminal 111c of the second cell 11-b is connected to the first section 22a1, the welding part 113a of the first terminal 113b of the third cell 11-c is connected to the second section 22a2, the welding part 113a of the second terminal 113c of the first cell 11-b is connected to the third section 22b1, and the welding part 113a of the first terminal 113b of the second cell 11-b is connected to the fourth section 22b2. When viewed along the third direction Z, along the second direction Y, the fourth section 22b2 and the second section 22a2 are arranged, the third section 22b1 and the first section 22a1 are arranged, and the third section 22b1 and the first section 22a1 are located between the fourth section 22b2 and the second section 22a2.

In an embodiment, a first protrusion 211b is provided within the first recess 2111. The first protrusion 211b is disposed between adjacent first conducting sheets 22a. The first protrusion 211b protrudes along a direction opposite to the third direction Z and extends in the second direction Y, dividing the first recess 2111 into a plurality of first sub-recesses 2111a arranged along the first direction X, where the first section 22a1, the first connecting segment 22a3, and the second section 22a2 are disposed within the first sub-recesses 2111a. Along the first direction X, projections of the first sections 22a1, projections of the first connecting segments 22a3, and projections of the second sections 22a2 are all within projections of the first protrusions 211b. Optionally, a projection of the welding part 113a connected to the first section 22a1 and the second section 22a2 is located within a projection of the first protrusion 211b. The adjacent first conducting sheets 22a and electrode terminals 113 connected to the first conducting sheets 22a are spaced apart to reduce the risk of an electrode terminal 113, in bending, coming into contact with an adjacent first conducting sheet 22a and an electrode terminal 113.

In an embodiment, a first protrusion 211b is provided within the second recess 2112. The first protrusion 211b is disposed between adjacent second conducting sheets 22b. The first protrusion 211b protrudes along a direction opposite to the third direction Z and extends in the second direction Y, dividing the second recess 2112 into a plurality of second sub-recesses 2112a arranged along the first direction X, where the third section 22b1, the second connecting segment 22b3, and the fourth section 22b2 are disposed within the second sub-recesses 2112a. Along the first direction X, projections of the third section 22b1, projections of the second connecting segments 22b3, and projections of the fourth sections 22b2 are all within projections of the first protrusions 211b. Optionally, a projection of the welding part 113a connected to the third section 22b1 and the fourth section 22b2 is located within a projection of the first protrusion 211b. The adjacent second conducting sheets 22b and electrode terminals 113 connected to the second conducting sheets 22b are spaced apart to reduce the risk of an electrode terminal 113, in bending, coming into contact with an adjacent second conducting sheet 22b and coming into contact with an adjacent electrode terminal 113.

Referring to FIG. 18 to FIG. 22, in an embodiment, along the first direction X, the width of the first section 22a1 and the width of the second section 22a2 are less than the width of the first sub-recess 2111a, and multiple sets of through holes 211c are provided in the first recess 2111, the multiple sets of through holes 211c running through the substrate 21a. Each set of through holes 211c includes a first through hole 2111c and a second through hole 2112c, and the first through hole 2111c and the second through hole 2112c are provided in each first sub-recess 2111a. The electrode terminal 113 of one cell 11 passes through the first through hole 2111c, bends, and connects to the first section 22a1, and the electrode terminal 113 of an adjacent cell 11 passes through the second through hole 2112c, bends, and connects to the second section 22a2. Optionally, the first section 22a1 is connected to the second terminal 113c, the second section 22a2 is connected to the first terminal 113b of the adjacent cell 11, or the first section 22a1 is connected to the first terminal 113b, and the second section 22a2 is connected to the second terminal 113c of the adjacent cell 11. The first terminal 113b and the second terminal 113c are bent in opposite directions.

In an embodiment, along the first direction X, a width of the first through hole 2111c is greater than a thickness of the electrode terminal 113, and a gap is formed between the electrode terminal 113 and the holder 21, facilitating passage of the electrode terminal 113 through the first through hole 2111c and reducing interference between the electrode terminal 113 and the holder 21.

In an embodiment, along the first direction X, a width of the second through hole 2112c is greater than the thickness of the electrode terminal 113, and a gap is formed between the electrode terminal 113 and the holder 21, facilitating passage of the electrode terminal 113 through the second through hole 2112c and reducing interference between the electrode terminal 113 and the holder 21.

In an embodiment, along the first direction X, the width of the third section 22b1 and the width of the fourth section 22b2 are less than a width of the second sub-recess 2112a. Multiple sets of through holes 211d running through the substrate 21a are provided in the second recess 2112. Each set of through holes 211d includes a third through hole 2111d and a fourth through hole 2112d, and the third through hole 2111d and the fourth through hole 2112d are provided in each second sub-recess 2112a. The electrode terminal 113 of one cell 11 passes through the third through hole 2111d, bends, and connects to the third section 22b1, and the electrode terminal 113 of an adjacent cell 11 passes through the fourth through hole 2112d, bends, and connects to the fourth section 22b2. Optionally, the third section 22b1 is connected to the second terminal 113c, the fourth section 22b2 is connected to the first terminal 113b of the adjacent cell 11, or the third section 22b1 is connected to the first terminal 113b, and the fourth section 22b2 is connected to the second terminal 113c of the adjacent cell 11. The first terminal 113b and the second terminal 113c are bent in a same direction. Optionally, the electrode terminals 113 connected to the first section 22a1 and the second section 22a2 have opposite polarities, and the electrode terminals 113 connected to the third section 22b1 and the third section 22b1 have opposite polarities.

In an embodiment, the first through hole 2111c and the second through hole 2112c in a same first sub-recess 2111a are disposed on different sides of a first conducting sheet 22a. The first through hole 2111c and the second through hole 2112c are arranged apart along the first direction X, facilitating passage of the electrode terminal 113.

In an embodiment, the third through hole 2111d and the fourth through hole 2112d in a same second sub-recess 2112a are disposed on a same side of a second conducting sheet 22b. The third through hole 2111d and the fourth through hole 2112d are arranged apart along the second direction Y, facilitating passage of the electrode terminal 113.

In an embodiment, a fifth through hole 2111e running through the substrate 21a is provided on one side of the third recess 2113, and the electrode terminal 113 passes through the fifth through hole 2111e and is connected to the fourth conducting sheet 22d in the third recess 2113. Optionally, along the first direction X, a width of the fourth conducting sheet 22d in the third recess 2113 is the same as the widths of the first section 22a1 and the second section 22a2 in the first recess 2111, and the widths of the third section 22b1 and the fourth section 22b2 in the second recess 2112, ensuring that the connection area between each conducting sheet 22 and the electrode terminal 113 is the same.

Referring to FIG. 5, FIG. 21, FIG. 22, and FIG. 23, in an embodiment, the M cells 11 include the first cell 11-a, the second cell 11-b, the third cell 11-c, the fourth cell 11-d, the fifth cell 11-e, the sixth cell 11-f, and the seventh cell 11-g stacked along the first direction X. Using the first terminal 113b as the positive electrode and the second terminal 113c as the negative electrode as an example, the first terminal 113b-a of the first cell 11-a is connected to the third conducting sheet 22c as an overall positive connection terminal, the second terminal 113c-a of the first cell 11-a is connected to the first terminal 113b-b of the second cell 11-b through the first conducting sheet 22a, and the second terminal 113c of the first cell 11-a and the first terminal 113b of the second cell 11-b are bent in different directions, facilitating the connection of the electrode terminals 113.

The second terminal 113c-b of the second cell 11-b is connected to the first terminal 113b of the third cell 11 through the second conducting sheet 22b, and the second terminal 113c of the second cell 11-b and the first terminal 113b of the third cell 11-c are bent in a same direction, facilitating the connection of the electrode terminals 113.

The second terminal 113c of the third cell 11-c is connected to the first terminal 113b of the fourth cell 11-d through the first conducting sheet 22a, and the second terminal 113c of the third cell 11-c and the first terminal 113b of the fourth cell 11-d are bent in different directions, facilitating the connection of the electrode terminals 113.

The second terminal 113c of the fourth cell 11-d is connected to the first terminal 113b of the fifth cell 11-e through the second conducting sheet 22b, and the second terminal 113c of the fourth cell 11-d and the first terminal 113b of the fifth cell 11-e are bent in a same direction, facilitating the connection of the electrode terminals 113.

The second terminal 113c of the fifth cell 11-e is connected to the first terminal 113b of the sixth cell 11-f through the first conducting sheet 22a, and the second terminal 113c of the fifth cell 11-e and the first terminal 113b of the sixth cell 11-f are bent in different directions, facilitating the connection of the electrode terminals 113.

The second terminal 113c of the sixth cell 11-f is connected to the first terminal 113b of the seventh cell 11-g through the second conducting sheet 22b, and the second terminal 113c of the sixth cell 11-f and the first terminal 113b of the seventh cell 11-g are bent in a same direction, facilitating the connection of the electrode terminals 113.

The second terminal 113c of the seventh cell 11-g is connected to the fourth conducting sheet 22d in the third recess 2113 as an overall negative connection terminal.

In an embodiment, along the third direction Z, after the electrode terminal 113 is bent, the welding part 113a overlaps with an adjacent cell 11. With the electrode terminals 113 of adjacent cells 11 being arranged in a non-overlapping manner, the electrode terminals 113 can be bent and extended to the adjacent cell 11. This can increase the width of the welding part 113a in the first direction X, thereby increasing the welding area between the welding part 113a and the conducting sheet 22. Optionally, along the first direction X, the width of the welding part 113a extending to the adjacent cell 11 is at least one-third of the thickness of the adjacent cell 11. For example, when viewed along the third direction Z, the welding part 113a of the second terminal 113c of the first cell 11-a extends along the first direction X to the second cell 11-b. The first terminal 113b of the second cell 11-b extends along a direction opposite to the first direction X to the first cell 11-a.

Referring to FIG. 19, FIG. 20, FIG. 24, FIG. 25, and FIG. 26, in an embodiment, the holder 21 further includes a plurality of second protrusions 21b, the plurality of second protrusions 21b are spaced apart along the first direction X on the second surface 202 of the substrate 21a, each second protrusion 21b extending along the third direction Z. When viewed along a direction opposite to the third direction Z, the multiple sets of through holes 211c and 211d are located between adjacent second protrusions 21b. Optionally, along the third direction Z, a projection of the first through hole 2111c, a projection of the second through hole 2112c, a projection of the third through hole 2111d, and a projection of the fourth through hole 2112d are located between projections of adjacent second protrusions 21b. The electrode terminal 113 passes through between adjacent second protrusions 21b. The second protrusion 21b provides insulation for a portion of the electrode terminal 113, reducing the risk of short circuits. Optionally, along the first direction X, a projection of the portion of the electrode terminal 113 not connected to the conducting sheet 22 is within the projection of the second protrusion 21b. Disposing the entire portion of the electrode terminal 113 not connected to the conducting sheet 22 between adjacent second protrusions 21b further reduces the risk of short circuits. Optionally, along the first direction X, a projection of the second portion 111b overlaps with a projection of the second protrusion 21b. Disposing at least a portion of the second portion 111b and the entire electrode terminal 113 between adjacent second protrusions 21b further reduces the risk of short circuits.

Referring to FIG. 26, in an embodiment, the second protrusion 21b includes a first inclined surface 210b, and an adjacent second protrusion 21b includes a second inclined surface 220b. A distance along the first direction X between the first inclined surface 210b and the second inclined surface 220b of the adjacent second protrusion 21b gradually increases in the third direction Z. This creates a flared gap between the first inclined surface 210b and the second inclined surface 220b, facilitating the guiding of the first terminal 113b and the second terminal 113c into a gap between adjacent second protrusions 21b, improving the success rate of aligning the cells 11 with the holder 21.

Referring to FIG. 20 and FIG. 24, in an embodiment, a plurality of spaced first partitions 230b are provided in the gap between adjacent second protrusions 21b, and the plurality of first partitions 230b are spaced apart along the second direction Y. Along the first direction X, a projection of the first partition 230b is located between a projection of the first terminal 113b and a projection of the second terminal 113c. The first partition 230b can insulate the first terminal 113b and the second terminal 113c, reducing the risk of short circuits, and divide the gap between adjacent second protrusions 21b into multiple separation zones 240b along the second direction Y, each separation zone 240b being configured to accommodate the first terminal 113b or the second terminal 113c. In aligning the cells 11 with the holder 21, the multiple separation zones 240b is used to facilitate the guiding of the first terminal 113b and the second terminal 113c and separate the first terminal 113b and the second terminal 113c of each cell 11 from each other, reducing the contact between the electrode terminals 113 and these of adjacent cells 11.

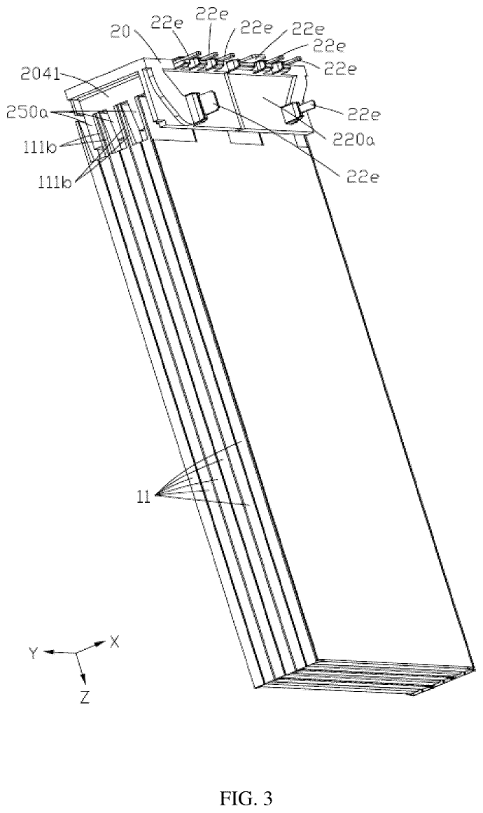

Referring to FIG. 3, FIG. 17, and FIG. 19, in an embodiment, the substrate 21a includes a first side edge 201a and a second side edge 202a disposed along the first direction X, the first side edge 201a is provided with a first side wall 210a, the second side edge 202a is provided with a second side wall 220a, and the first side wall 210a and the second side wall 220a are arranged to extend along the third direction. The second protrusion 21b is disposed between the first side wall 210a and the second side wall 220a. Along the first direction X, a projection of the second protrusion 21b is within a projection of the first side wall 210a and a projection of the second side wall 220a. The second protrusions can provide further insulation for the electrode terminals 113 located between adjacent second protrusions 21b, reducing the risk of short circuits. Along the first direction X, a projection of the second portion 111b overlaps with the projection of the first side wall 210a and the projection of the second side wall 220a, and the second portion 111b can be protected.

In an embodiment, the first cell 11-a located on the outermost side is partially disposed on a side of the first side wall 210a away from the second side wall 220a. Optionally, the second portion 111b and the electrode terminal 113 extending out of the second portion 111b are disposed on a side of the first side wall 210a away from the second side wall 220a. The holder 21 further includes a fourth recess 230a, the fourth recess 230a communicates with the first recess 2111, an electrode terminal 113 of the first cell 11-a is disposed on the fourth recess 230a and extends into the first recess 2111 to connect to the first section 22a1. Along the second direction Y, a projection of a portion of the electrode terminal 113 is within a projection of the fourth recess 230a. The fourth recess 230a is used to accommodate the electrode terminal 113, limiting and protecting the electrode terminal 113. Optionally, the fourth recess 230a is disposed on the first side edge 201a of the substrate 21a. Optionally, the fourth recess 230a is disposed on a side of the first side wall 210a away from the second side wall 220a and extends to the first side edge 201a of the substrate 21a. In an embodiment, the third conducting sheet 22c is disposed on the side of the first side wall 210a away from the second side wall 220a and is spaced apart from the fourth recess 230a. The third conducting sheet 22c located on the first side wall 210a is configured to connect the other electrode terminal 113 of the first cell 11-a for input or output of electric energy, for example, as an overall positive connection terminal or an overall negative connection terminal.

In some embodiments, the welding part 113a of the first terminal 113b of the first cell 11-a is a flat plate structure.

Referring to FIG. 19 and FIG. 24 to FIG. 28, in an embodiment, the substrate 21a includes a third side edge 203a and a fourth side edge 204a disposed along the second direction Y. The third side edge 203a is provided with a third side wall 2031, and the third side wall 2031 is connected to the first side wall 210a, the second side wall 220a, and the second surface 202. The fourth side edge 204a is provided with a fourth side wall 2041, and the fourth side wall 2041 is connected to the first side wall 210a, the second side wall 220a, and the second surface 202. The third side wall 2031 and the fourth side wall 2041 are arranged along the second direction Y. The third side wall 2031 is provided with a plurality of third protrusions 240a spaced apart along the first direction X, a fifth gap 2410 is provided between adjacent third protrusions 240a, and starting from the second cell 11-b, the second portions 111b of adjacent cells 11 are disposed in a same fifth gap 2410. The fourth side wall 2041 is provided with a plurality of fourth protrusions 250a spaced apart along the first direction X, a sixth gap 2510 is provided between adjacent fourth protrusions 250a, and starting from the second cell 11-b, the second portions 111b of adjacent cells 11 are disposed in a same sixth gap 2510. Specifically, using M=7 and N=8 as an example for illustration, the second cell 11-b and the third cell 11-c each have one end disposed in a same fifth gap 2410 and the other end disposed in a same sixth gap 2510. The fourth cell 11-d and the fifth cell 11-e each have one end disposed in another same fifth gap 2410 and the other end disposed in another same sixth gap 2510. The sixth cell 11-f and the seventh cell 11-g each have one end disposed in yet another same fifth gap 2410 and the other end disposed in yet another same sixth gap 2510.

Along the second direction Y, the plurality of second protrusions 21b are disposed between the third protrusions 240a and the fourth protrusions 250a. The third protrusions 240a and the fourth protrusions 250a extend along the third direction Z. Along the second direction Y, projections of the third protrusions 240a overlap with projections of the fourth protrusions 250a. Along the third direction Z, the third protrusion 240a extends farther than the second protrusion 21b, and the fourth protrusion 250a extends farther than the second protrusion 21b. Along the first direction X, the projection of the second portion 111b overlaps with the projection of the third protrusion 240a, and the projection of the second portion 111b overlaps with the projection of the fourth protrusion 250a. When viewed along the third direction Z, one end of the second portion 111b extends out of the third protrusion 240a along the direction opposite to the second direction Y, and the other end extends out of the fourth protrusion 250a along the second direction Y. Disposing the second portion 111b between adjacent third protrusions 240a and between adjacent fourth protrusions 250a facilitates positioning of the second portion 111b by adjusting a distance between the second portion 111b and the substrate 21a along the third direction Z and facilitates production.

In an embodiment, the third protrusion 240a is provided with a third inclined surface 2401, and an adjacent third protrusion 240a is provided with a fourth inclined surface 2402. A distance along the first direction X between the third inclined surface 2401 and the fourth inclined surface 2402 of the adjacent third protrusion 240a gradually increases in the third direction Z. This creates a flared gap between the third inclined surface 2401 and the fourth inclined surface 2402, facilitating the guiding of the second portion 111b into a gap between adjacent third protrusions 240a. Optionally, the adjacent fourth protrusion 250a is also provided with a third inclined surface 2401 and a fourth inclined surface 2402.

In an embodiment, the third side edge 203a is provided with a first protrusion 205a extending along a direction opposite to the second direction Y, and the fourth side edge 204a is provided with a second protrusion 206a extending along the second direction Y. The first protrusion 205a and the second protrusion 206a can support the entire connecting assembly 20, facilitating welding.

In an embodiment, referring to FIG. 17, FIG. 22, FIG. 24, and FIG. 29 to FIG. 32, the conducting sheet 22 includes conducting extension parts 22e. The conducting extension parts 22e extend out of the substrate 21a along the first direction X for connecting with other conductive components. A plurality of conducting extension parts 22e are spaced apart along the second direction Y, facilitating the welding of the conducting extension parts 22e with other conductive components and reducing damage to the cells 11 during welding. Optionally, the conducting extension parts 22e are connected to a circuit board 30 to implement the connection between the cells 11 and the circuit board 30, thereby collecting electrical signals from the cells 11, reducing the use of sampling terminals and sampling harnesses, and reducing the quantity of materials. Optionally, the circuit board 30 may collect information of the cells 11 such as current, voltage, resistance, and temperature. Optionally, the circuit board 30 includes a BMS component (Battery Management System). Specifically, the BMS component includes multiple electronic components, and the multiple electronic components can implement functions such as data collection, control, protection, communication, power level calculation, signal transmission, and electric energy transmission of the battery. Optionally, the circuit board 30 includes a flexible printed circuit (FPC, Flexible Printed Circuit). Optionally, the circuit board 30 includes a printed circuit board (PCB, Printed Circuit Board), and multiple conductor traces (not shown) are provided on the circuit board 30.

In an embodiment, each first conducting sheet 22a further includes a first conducting extension part 22a4, and the first conducting extension part 22a4 extends out of the substrate 21a along the first direction X. Optionally, the first conducting extension part 22a4 is connected to the circuit board 30.

In an embodiment, each second conducting sheet 22b further includes second conducting extension parts 22b4, the second conducting extension parts 22b4 extend out of the substrate 21a along the first direction X, and the first conducting extension parts 22a4 and the second conducting extension parts 22b4 are spaced apart. Optionally, the second conducting extension parts 22b4 are connected to the circuit board 30.

In an embodiment, the third conducting sheet 22c further includes a third conducting extension part 22cl, the third conducting extension part 22cl extends out of the substrate 21a along the first direction X, and the third conducting extension part 22cl and the second conducting extension parts 22b4 are spaced apart along the second direction Y. Optionally, the third conducting extension part 22cl is connected to the circuit board 30.

In an embodiment, the fourth conducting sheet 22d further includes a fourth conducting extension part 22d1, the fourth conducting extension part 22d1 extends out of the substrate 21a along the first direction X, and the fourth conducting extension part 22d1 and the third conducting extension part 22cl are spaced apart. Optionally, the fourth conducting extension part 22d1 is connected to the circuit board 30.

In an embodiment, the conducting sheet 22 further includes a connecting part 22f, and the connecting part 22f is disposed within the substrate 21a. The substrate 21a covers the connecting part 22f for insulating the connecting part 22f, reduces materials, and positions the plurality of conducting sheets 22, reducing the risk of short circuits caused by contact between the plurality of conducting sheets 22.

In an embodiment, each first conducting sheet 22a further includes a first connecting part 22a5, the first connecting part 22a5 is disposed within the substrate 21a, and the first connecting part 22a5 is connected to any one of the first section 22a1, the second section 22a2, and the first connecting segment 22a3. A first conducting extension part 22a4 is connected to the first connecting part 22a5. Connecting the first connecting part 22a5 to any one of the first section 22a1, the second section 22a2, and the first connecting segment 22a3 can facilitate adjusting the position of the first connecting part 22a5 and reducing interference between the first connecting parts 22a5 of the plurality of first conducting sheets 22a, and facilitate adjusting the positions of the first conducting extension parts 22a4 and reducing interference between the first conducting sheets 22a and the second conducting sheets 22b.

In an embodiment, each second conducting sheet 22b further includes a second connecting part 2265, the second connecting part 22b5 is disposed within the substrate 21a, and the second connecting part 2265 is connected to any one of the third section 22b1, the fourth section 22b2, and the second connecting segment 22b3. A second conducting extension part 22b4 is connected to the second connecting part 22b5 Connecting the second connecting part 22b5 to any one of the third section 22b1, the fourth section 22b2, and the second connecting segment 22b3 can facilitate adjusting the position of the second connecting part 22b5 and reducing interference between the second connecting parts 2265 of the plurality of second conducting sheets 22b, and facilitate adjusting the positions of the second conducting extension parts 22b4 and reducing interference between the first connecting part 22a5 and the second connecting part 22b5.

In an embodiment, each third conducting sheet 22c further includes a third connecting part 22c2, the third connecting part 22c2 is disposed within the substrate 21a, and the third connecting part 22c2 is connected to the third conducting extension part 22cl.

In an embodiment, each fourth conducting sheet 22d further includes a fourth connecting part 22d2, the fourth connecting part 22d2 is disposed within the substrate 21a, and the fourth connecting part 22d2 is connected to the fourth conducting extension part 22d1.

In an embodiment, at least a portion of the connecting part 22f is bent, further increasing the distance between adjacent conducting extension parts 22e, further reducing the risk of short circuits caused by contact between adjacent conducting extension parts 22e. This further facilitates the welding of the conducting extension parts 22e with the circuit board 30, further reducing damage to the cells 11 during welding.

Using a first conducting sheet 22a as an example for illustration, the first connecting part 22a5 includes a first sub-part 22a51 and a second sub-part 22a52, the first sub-part 22a51 is bent toward the second side wall 220a along the first direction X, the second sub-part 22a52 is bent away from the second side wall 220a along the second direction Y, and the second sub-part 22a52 is connected to the first sub-part 22a51 and the first conducting extension part 22a4.

Using a third conducting sheet 22c as an example for illustration, the third connecting part 22c2 includes a third sub-part 22c21 and a fourth sub-part 22c22, the third sub-part 22c21 is bent toward the second side wall 220a along the first direction X, the fourth sub-part 22c22 is bent away from the second side wall 220a along the second direction Y, and the fourth sub-part 22c22 is connected to the third sub-part 22c21 and the third conducting extension part 22cl.

Referring to FIG. 31 and FIG. 32, in an embodiment, a battery cell assembly 100 further includes a shell 40. The shell 40 includes a first shell 40a and a second shell 40b, the first shell 40a is connected to the second shell 40b to form a first space 40c, a cell assembly 10 and a portion of a connecting assembly 20 are disposed in the first space 40c, and the connecting assembly 20 is positioned with the shell 40 through a first protrusion 205a and a second protrusion 206a. A circuit board 30 is disposed on a side of the shell 40 away from the cell assembly 10. The shell 40 is provided with a plurality of first holes 41, and the cells 11 are connected to the circuit board 30 through the first holes 41. Along the first direction X, a projection of the conducting extension part 22e is within a projection of the first hole 41. The circuit board 30 is provided with a plurality of second holes 31, the conducting extension parts 22e pass through the first holes 41 and are disposed in the second holes 31, and the conducting extension parts 22e are fixedly connected to the circuit board 30 by welding or conductive adhesive.

In an embodiment, an insulating member 50 is provided between the cells 11 and the inner wall of the shell 40 to secure the position of the cells 11 and buffer the cells 11. Optionally, the insulating member 50 includes foam.

In an embodiment, the circuit board 30 is further provided with a sampling member 32. One end of the sampling member 32 is connected to the circuit board 30, and the other end is connected to any electrode terminal 113 for obtaining the temperature of a cell 11.

Referring to FIG. 33, this application further provides an electric device 200 using the foregoing battery cell assembly 100. In an embodiment, the electric device 200 in this application may be but is not limited to a drone, a cleaning tool, a backup power source, an electric automobile, an electric motorcycle, an electrically assisted bicycle, an electric tool, or a large household battery.

Those of ordinary skill in the art should appreciate that some foregoing embodiments are for description of this application only but not for limiting this application. Appropriate modifications and variations made to the foregoing embodiments without departing from the essential spirit and scope of this application all fall within the scope disclosed in this application.

What is claimed is:

1. A battery cell assembly, comprising:
a cell assembly comprising M cells stacked along a first direction; each cell comprises a cell housing, an electrode terminal, and an electrode assembly disposed within the cell housing; the electrode terminal is connected to the electrode assembly and extends out of the cell housing, a welding part is provided on a portion of the electrode terminal located outside the cell housing; and along the first direction, a projection of the welding part of the each cell is spaced apart from a projection of the welding part of an adjacent cell; and
a holder and N conducting sheets, wherein the N conducting sheets are disposed on the holder and the N conducting sheets are spaced apart from each other, at least a portion of each conducting sheet is exposed through the holder, the electrode terminal of the each cell passes through the holder, and the welding part of the electrode terminal is connected to the portion of the conducting sheet exposed through the holder.

2. The battery cell assembly according to claim 1, wherein the holder is provided with a recess, the recess comprises a first recess and a second recess spaced apart along a second direction;
the conducting sheets comprise a plurality of first conducting sheets and a plurality of second conducting sheets, the first conducting sheets are disposed on the first recess, the second conducting sheets are disposed on the second recess;
the electrode terminal comprises a first terminal and a second terminal with opposite polarities, one of the first terminal or the second terminal of each cell positioned between a first cell and an M-th cell is disposed on the first recess and connected to the first conducting sheet, and the other of the first terminal or the second terminal of the each cell positioned between the first cell and the M-th cell is disposed on the second recess and connected to the second conducting sheet, and the second direction is perpendicular to the first direction.

3. The battery cell assembly according to claim 2, wherein first protrusions are provided both between adjacent first conducting sheets and between adjacent second conducting sheets;
along the first direction, a projection of the welding part is located within a projection of the first protrusion.

4. The battery cell assembly according to claim 2, wherein for each cell positioned between a second cell and an M−1-th cell, one welding part of the each cell positioned between the second cell and the M−1-th cell and one welding part of the cell adjacent to the each cell positioned between the second cell and the M−1-th cell is connected to a same first conducting sheet or a same second conducting sheet as the welding part of the electrode terminal of the cell adjacent to the each cell positioned between the second cell and the M−1-th cell.

5. The battery cell assembly according to claim 2, wherein the conducting sheets further comprise a third conducting sheet, the recess further comprises a third recess, the first recess and the third recess are spaced apart along the first direction;
at least a portion of the third conducting sheet is exposed to the third recess, and the second terminal of the M-th cell is connected to the portion of the third conducting sheet exposed to the third recess.

6. The battery cell assembly according to claim 2, wherein the holder comprises a substrate and a plurality of second protrusions, the substrate comprises a first surface and a second surface disposed opposite to each other along a third direction, the recess is provided on the first surface, the plurality of second protrusions are spaced apart on the second surface;
along the first direction, a projection of the electrode terminal overlaps with a projection of the second protrusion, the third direction is perpendicular to both the first direction and the second direction.

7. The battery cell assembly according to claim 6, wherein the cell housing comprises a first portion and a second portion, the electrode assembly is disposed in the first portion, the second portion is connected to the first portion, the electrode terminal is connected to the electrode assembly and extends out of the second portion;
along the first direction, a projection of the second portion overlaps with a projection of the second protrusions.

8. The battery cell assembly according to claim 6, wherein a plurality of first partitions are provided between adjacent second protrusions; and along the first direction, a projection of the first partitions is located between a projection of one first terminal and a projection of one second terminal, the first terminal and second terminal are disposed on the same first recess or the same second recess.

9. The battery cell assembly according to claim 6, further comprising a circuit board, each conducting sheet further comprises conducting extension parts, and the conducting extension parts extend out of the substrate and are connected to the circuit board.

10. The battery cell assembly according to claim 2, wherein the electrode terminals of adjacent cells are disposed at different positions on the cell housings; along the second direction, a width of the first terminal is W₁, a width of the second terminal is W₂; and along the second direction, a distance between opposing edges of the first terminal and the second terminal of one cell is W₃, and a distance between opposing edges of the first terminal and the second terminal of another adjacent cell is W₄, wherein W₁+W₂+W₃<W₄.

11. The battery cell assembly according to claim 2, wherein the cell housing comprises a first side edge and a second side edge arranged opposite to each other along the second direction and along the second direction, a distance between the first side edge and the second side edge is W, a distance between an edge of the first terminal closest to the first side edge and the first side edge is F₁, a distance between an edge of the second terminal closest to the second side edge and the second side edge is F₂, a width of the first terminal is W₁, and a width of the second terminal is W₂, satisfying F₁+W₁<F₂ and 2*(F₂+W₂)<W.

12. The battery cell assembly according to claim 11, wherein along the second direction, a distance between the second terminals of adjacent cells is d, and d=[W−F₁−F₁−2*(W₁+W₂)]/3.

13. A battery cell assembly, comprising:
a cell assembly comprises M cells in stacked arrangement along a first direction, each cell comprises a cell housing, an electrode terminal, and an electrode assembly disposed within the cell housing, the electrode terminal is connected to the electrode assembly and extends out of the cell housing, a welding part is provided on a portion of the electrode terminal located outside the cell housing, along the first direction, a projection of the welding part of any cell and a projection of the welding part of an adjacent cell are spaced apart from each other; and M≥3; and
N conducting sheets, wherein adjacent cells are connected through the conducting sheets, and the welding part is connected to the conducting sheet, wherein N=M+1.

14. The battery cell assembly according to claim 13, wherein the electrode terminal comprises a first terminal and a second terminal with opposite polarities, and the second terminal of any cell between a first cell and an M-th cell and the first terminal of an adjacent cell are connected to a same conducting sheet.

15. The battery cell assembly according to claim 14, wherein when viewed along a third direction, along the first direction, the welding parts of the first terminals of even-numbered cells are spaced apart from each other, the welding parts of the second terminals of odd-numbered cells are spaced apart from each other, the welding parts of the second terminals of the even-numbered cells are spaced apart from each other, and the welding parts of the first terminals of the odd-numbered cells are spaced apart from each other, the third direction is perpendicular to the first direction.

16. The battery cell assembly according to claim 15, wherein the first terminal of the first cell serves as a first output terminal of the cell assembly, the second terminal of the M-th cell serves as a second output terminal of the cell assembly, and the welding part of the second terminal of the first cell and the welding part of the first terminal of the second cell are connected by a same conducting sheet.

17. The battery cell assembly according to claim 16, wherein the conducting sheets comprise a plurality of first conducting sheets and a plurality of second conducting sheets; when viewed along the third direction, along the first direction, the plurality of first conducting sheets are spaced apart, the plurality of second conducting sheets are spaced apart;
each of the first conducting sheets comprises a first section and a second section for connecting the electrode terminals; and along the first direction, the first section of the same first conducting sheet is closer to the first cell than the second section.

18. The battery cell assembly according to claim 17, wherein M is an odd number, and each of the first sections is connected to the second terminals of the odd-numbered cells, and each of the second sections is connected to the first terminals of the even-numbered cells.

19. The battery cell assembly according to claim 17, wherein M is an even number, and each of the first sections is connected to the second terminals of the even-numbered cells, and each of the second sections is connected to the first terminals of the odd-numbered cells.

20. An electric device, comprising the battery cell assembly according to claim 1.
